(19) United States
(12) Patent Application Publication
(10) Pub. No.: US 2012/0268621 A1
(43) Pub. Date: Oct. 25, 2012

(54) IMAGING APPARATUS, AZIMUTH RECORDING METHOD, AND PROGRAM

(75) Inventors: Hiroshi Kanma, Kanagawa (JP); Ryunosuke Oda, Tokyo (JP)

(73) Assignee: SONY CORPORATION, Tokyo (JP)

(21) Appl. No.: 13/517,369

(22) PCT Filed: Sep. 8, 2010
(86) PCT No.: PCT/JP2010/065425

§ 371 Date: Jun. 20, 2012

(30) Foreign Application Priority Data
Dec. 28, 2009 (JP) 2009-298943

(51) Int. Cl. H04N 5/225

(52) U.S. Cl. 348/222.1; 348/E05.024

(57) ABSTRACT

Provided is an imaging apparatus including an imaging unit configured to capture an object according to an imaging start instruction and output a captured image, a geomagnetic sensor configured to detect geomagnetism, an imaging controlling unit configured to control components of the imaging unit in an imaging processing period from the imaging start instruction to the output of the captured image and determine an operation period of a magnetic field generating component affecting a detection value of the geomagnetic sensor, among the components of the imaging unit, an azimuth calculating unit configured to calculate an imaging azimuth based on the detection value detected by the geomagnetic sensor, in a period other than an operation period of the magnetic field generating component, during the imaging processing period, and a recording unit configured to record the imaging azimuths on a recording medium in association with the captured image.

### TECHNICAL FIELD

The present invention relates to an imaging apparatus, an azimuth recording method, and a program.

### BACKGROUND ART

In recent years, in imaging apparatuses such as digital cameras, models on which an electronic compass is mounted have emerged. An electronic compass has a function of electronically calculating a front azimuth of a device, based on geomagnetism detected by a geomagnetic sensor. By mounting an electronic compass on a digital camera, a two-dimensional compass image representing a front azimuth of the digital camera (for example, imaging azimuth) is displayed on a displaying unit, so that the imaging azimuth can be recognized by a photographer, and imaging azimuth information can be recorded as additional information of a captured image.

However, since a geomagnetic sensor detecting weak geomagnetism also detects a magnetic field generated by various components of an electronic device as a disturbance, a geomagnetism detection error occurs. For this reason, when a component generating a magnetic field acting as the disturbance (hereinafter referred to as a disturbance component) is operated, the electronic compass may not position an azimuth correctly. In order to cope with such a problem, for example, Patent Literature 1 discloses a technology of predetermining a correction value for correcting a detection value of a geomagnetic sensor, in each state of a disturbance component, and correcting the detection value of the geomagnetic sensor by using the correction value corresponding to the state of the disturbance component, when positioning an azimuth.

### CITATION LIST

### Patent Literature

Patent Literature 1: JP 2005-291936A

### SUMMARY OF INVENTION

### Technical Problem

However, in a use case in which an imaging azimuth is recorded as additional information of a captured image (for example, picture) in a digital camera or the like, it is necessary to detect an imaging azimuth within a limited short period corresponding to an imaging timing (for example, in a release operation).

However, in a short period from a release operation to an image capturing and recording operation, a plurality of disturbance components such as a shutter, a dark filter, a focus lens, and a flash are operated, and the respective disturbance components are operated instantaneously at different times. In addition, when such disturbance components are not exclusively operated, it is necessary to cancel a plurality of disturbances in a combined manner. Accordingly, it is difficult to suitably correct all of the plurality of disturbances within the short period corresponding to the imaging timing. On the other hand, when geomagnetic data detected at a timing deviating from the short period corresponding to the imaging timing is used, it may be impossible to correctly detect an azimuth at the imaging timing.

Accordingly, in consideration of the above circumstances, the present invention is provided to calculate a correct imaging azimuth from which the influence of a disturbance is removed, within a short period corresponding to an imaging timing.

### Solution to Problem

According to the first aspect of the present invention in order to achieve the above-mentioned object, there is provided an imaging apparatus including: an imaging unit configured to capture an object according to an imaging start instruction and output a captured image; a geomagnetic sensor configured to detect geomagnetism; an imaging controlling unit configured to control components of the imaging unit in an imaging processing period from the imaging start instruction to the output of the captured image, and determine an operation period of a magnetic field generating component affecting a detection value of the geomagnetic sensor, among the components of the imaging unit; an azimuth calculating unit configured to calculate imaging azimuths based on the detection value detected by the geomagnetic sensor in a period other than the operation period of the magnetic field generating component during the imaging processing period; and a recording unit configured to record the imaging azimuths on a recording medium in association with the captured image.

The imaging apparatus further includes: an azimuth storing unit configured to store the imaging azimuths calculated by the azimuth calculating unit, wherein the imaging controlling unit instructs the azimuth calculating unit to start positioning of the imaging azimuths when imaging processing is started by the imaging unit according to the imaging start instruction, instructs the azimuth calculating unit to stop the positioning of the imaging azimuth when an operation of the magnetic field generating component is started during the imaging processing period, instructs the azimuth calculating unit to restart the positioning of the imaging azimuth when the operation of the magnetic field generating component is ended during the imaging processing period, and instructs the azimuth calculating unit to stop the positioning of the imaging azimuth when the imaging processing is ended, wherein the azimuth calculating unit sequentially calculates the imaging azimuths based on the detection value of the geomagnetic sensor, in a period from the positioning start to the positing stop instructed by the imaging controlling unit during the imaging processing period, and records the plurality of calculated imaging azimuths in the azimuth storing unit, and calculates an average of the plurality of imaging azimuths stored in the azimuth storing unit, when the imaging processing is ended, and wherein the recording unit records the average of the imaging azimuths on the recording medium in association with the captured image.

The imaging apparatus further includes: an azimuth storing unit configured to store the imaging azimuths calculated by the azimuth calculating unit, wherein the imaging controlling unit instructs the azimuth calculating unit to start positioning of the imaging azimuths when imaging processing is started by the imaging unit according to the imaging start instruction, generates operation period information representing an operation start time point and an operation end time point of the magnetic field generating component during the imaging processing period, and, when the imaging processing is ended, instructs the azimuth calculating unit to stop the positioning of the imaging azimuths, and provides the operation period information to the azimuth calculating unit, wherein the azimuth calculating unit sequentially calculates the imaging azimuth based on the detection value of the geomagnetic sensor in the imaging processing period, and records the plurality of calculated imaging azimuths and calculation time information representing a calculation time point of each of the plurality of calculated imaging azimuths in the azimuth storing unit in an associated manner, and when the imaging processing period is ended, extracts the imaging azimuth calculated in a period other than an operation period of the magnetic field generating component among the imaging processing period, among the plurality of imaging azimuths stored in the azimuth storing unit, based on the operation period information acquired from the imaging controlling unit and the calculation time information stored in the azimuth storing unit, and calculates an average of the extracted imaging azimuths, and wherein the recording unit records the average of the imaging azimuths on the recording medium in association with the captured image.

The imaging apparatus further includes: a table associating identification information of the magnetic field generating component with influence degree information of the magnetic field generating component with respect to the detection value of the geomagnetic sensor, wherein the imaging controlling unit specifies the magnetic field generating component among the components of the imaging unit based on the identification information of the magnetic field generating component included in the table, and determines an operation period of the magnetic field generating component, and wherein, if the number of the extracted imaging azimuths is smaller than or equal to a predetermined number, the azimuth calculating unit selects a magnetic field generating component having a relatively small influence degree with respect to the detection value of the geomagnetic sensor, among the magnetic field generating components, based on the influence degree information of the magnetic field generating component included in the table, and calculates an average of the imaging azimuths by using the imaging azimuth calculated in a period when only the selected magnetic field generating component is operated and the extracted imaging azimuth.

According to the second aspect of the present invention in order to achieve the above-mentioned object, there is provided a method of recording an azimuth, including: a step of starting imaging processing of capturing an object by an imaging unit according to an imaging start instruction and outputting a captured image; a step of controlling components of the imaging unit in an imaging processing period from the imaging start instruction to an output of the captured image, and determining an operation period of a magnetic field generating component affecting a detection value of the geomagnetic sensor, among the components of the imaging unit; a step of calculating an imaging azimuth based on the detection value detected by the geomagnetic sensor, in a period other than the operation period of the magnetic field generating component, during the imaging processing period; and a step of recording the imaging azimuth on a recording medium in association with the captured image.

According to the third aspect of the present invention in order to achieve the above-mentioned object, there is provided a program for causing a computer to execute: a step of starting imaging processing of capturing an object by an imaging unit according to an imaging start instruction and outputting a captured image; a step of controlling components of the imaging unit in an imaging processing period from the imaging start instruction to an output of the captured image, and determining an operation period of a magnetic field generating component affecting a detection value of the geomagnetic sensor, among the components of the imaging unit; a step of calculating an imaging azimuth based on the detection value detected by the geomagnetic sensor, in a period other than the operation period of the magnetic field generating component, during the imaging processing period; and a step of recording the imaging azimuth on a recording medium in association with the captured image.

According to the above configuration, imaging processing of capturing an object by an imaging unit and outputting a captured image is started according to an imaging start instruction. Next, in an imaging processing period from the imaging start instruction to the output of the captured image, components of the imaging unit are controlled to determine an operation period of a magnetic field generating component affecting the detection value of the geomagnetic sensor, among the components of the imaging unit. In addition, an imaging azimuth is calculated based on the detection value detected by the geomagnetic sensor in the period other than the operation period of the magnetic field generating component during the imaging processing period. Thereafter, the imaging azimuth is recorded on a recording medium in relation to the captured image. The detection value detected by the geomagnetic sensor in the non-operation period of the magnetic field generating component removes the influence of a disturbance magnetic field generated by the magnetic field generating component. Accordingly, the azimuth calculating unit may use the detection value of the geomagnetic sensor to calculate a correct imaging azimuth in the imaging processing period.

### Advantageous Effects of Invention

As described above, according to the present invention, a correct imaging azimuth from which the influence of a disturbance is removed can be calculated within a short period corresponding to an imaging timing.

### BRIEF DESCRIPTION OF DRAWINGS

FIG. 1 is a block diagram illustrating a hardware configuration of an imaging apparatus according to a first embodiment of the present invention.

FIG. 2 is a block diagram illustrating a functional configuration of the imaging apparatus according to the first embodiment of the present invention.

FIG. 3 is a perspective view illustrating an imaging direction and attitude of the imaging apparatus according to the first embodiment of the present invention.

FIG. 4 is a rear view illustrating a display screen of the imaging apparatus in the state of FIG. 3.

FIG. 5 is a diagram illustrating a zoom position correction table retained by a controlling unit according to the first embodiment of the present invention.

FIG. 6 is a diagram illustrating a disturbance table retained by the controlling unit according to the first embodiment of the present invention.

FIG. 7 is a flow chart illustrating an imaging azimuth calculating and recording method according to the first embodiment of the present invention.

FIG. 8 is a timing chart illustrating an operation period of a disturbance component and a positioning period by an azimuth calculating unit according to the first embodiment of the present invention.

FIG. 9 is a block diagram illustrating a functional configuration of an imaging apparatus according to a second embodiment of the present invention.

FIG. 10 is a diagram illustrating a disturbance table retained by a controlling unit according to the second embodiment of the present invention.

FIG. 11 is a flow chart illustrating an imaging azimuth calculating and recording method according to the second embodiment of the present invention.

FIG. 12 is a timing chart illustrating an operation period of a disturbance component and an effective period of azimuth calculation according to the second embodiment of the present invention.

FIG. 13 is a timing chart illustrating an operation period of a disturbance component and an effective period of azimuth calculation according to an application example of the second embodiment of the present invention.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

In addition, a description will be given in the following order.
1. First Embodiment

1.1. Hardware Configuration of Imaging Apparatus

1.2. Functional Configuration of Imaging Apparatus
1.2.1. Imaging Azimuth Calculation Processing
1.2.2. Imaging Azimuth Displaying Processing
1.2.3. Imaging Processing
1.2.4. Azimuth Calculation Processing in Imaging Processing Period
1.2.5. Captured Image and Imaging Azimuth Recording Processing
1.2.5. Imaging Azimuth Reproducing and Displaying Processing

1.3. Imaging Azimuth Calculating and Recording Method

1.4. Imaging Azimuth Calculation Timing
2. Second Embodiment

2.1. Functional Configuration of Imaging Apparatus

2.2. Azimuth Calculation Processing in Imaging Processing Period

2.3. Imaging Azimuth Calculating and Recording Method

2.4. Imaging Azimuth Calculation Timing

2.5. Application Example of Imaging Azimuth Calculation
3. Conclusion
[1. First Embodiment]

First, an imaging apparatus and an azimuth recording method thereof according to a first embodiment of the present invention will be described.
[1.1. Hardware Configuration of Imaging Apparatus]

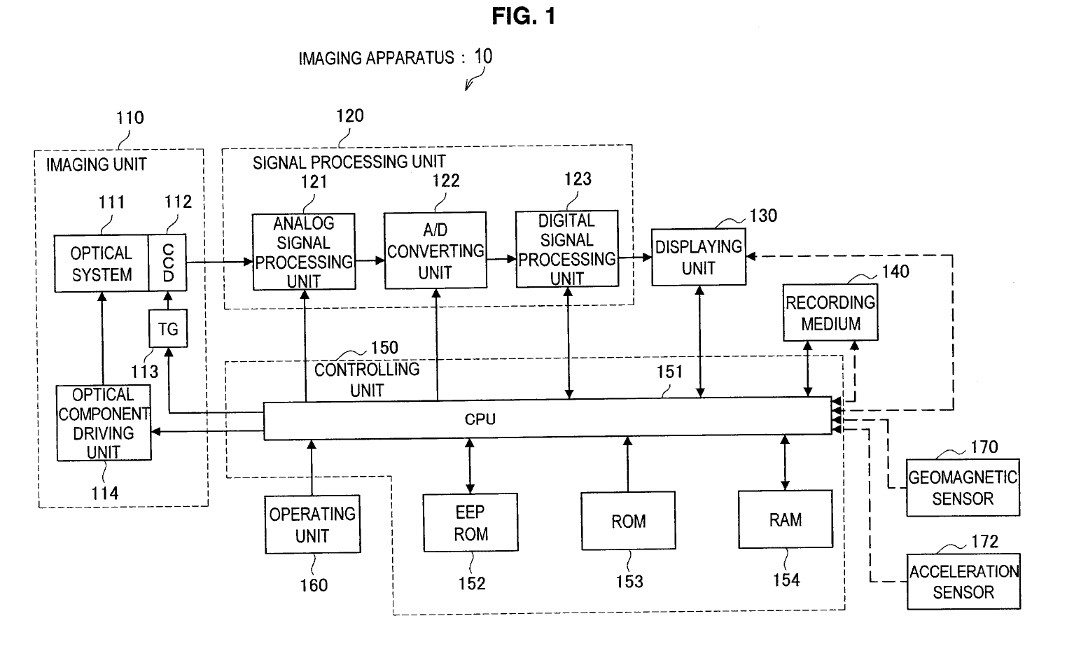

First, a hardware configuration of an imaging apparatus 10 according to a first embodiment of the present invention will be described in detail with reference to FIG. 1. FIG. 1 is a block diagram illustrating a hardware configuration of the imaging apparatus 10 according to the first embodiment of the present invention. An imaging apparatus of the present invention is realized by, for example, a digital camera such as the imaging apparatus 10 illustrated in FIG. 1. However, the present invention is not limited to such an example, but may be applicable to any electronic device that has an imaging function.

As illustrated in FIG. 1, the imaging apparatus 10 according to the first embodiment of the present invention includes, for example, a digital camera capable of capturing a still image (picture) or a moving image (for example, digital still camera or digital video camera). The imaging apparatus 10 captures an object, and records a captured image obtained by the image capturing (which may be either a still image or a moving image)on a recording medium as image data of a digital format.

As illustrated in FIG. 1, the imaging apparatus 10 according to the first embodiment of the present invention schematically includes an imaging unit 110, a signal processing unit 120, a displaying unit 130, a recording medium 140, a controlling unit 150, an operating unit 160, a geomagnetic sensor 170, and an acceleration sensor 172.

The imaging unit 110 captures an object and outputs an analog image signal representing a captured image. The imaging unit 110 includes an optical imaging system 111, an imaging device 112, a timing generator 113, and an optical component driving unit 114.

The optical imaging system 111 includes various lenses such as a focus lens, a zoom lens, and a correction lens, an optical filter removing an unnecessary wavelength, and optical components such as a shutter and a diaphragm. An optical image incident from an object (object image) is formed on an exposure side of the imaging device 112 through the respective optical components of the optical imaging system 111. The imaging device 112 (image sensor) includes, for example, a solid-state image sensing device such as a Charge Coupled Device (CCD) or a Complementary Metal Oxide Semiconductor (CMOS). The imaging device 112 photoelectrically converts an optical image derived from the optical imaging system 111, and outputs an electrical signal (analog image signal) representing a captured image.

The optical component driving unit 114 for driving the optical components of the optical imaging system 111 is mechanically connected to the optical imaging system 111. The optical component driving unit 114 includes, for example, a zoom motor, a focus motor, a diaphragm adjusting mechanism, and the like, and moves a zoom lens and a focus lens or adjusts a diaphragm. The optical component driving unit 114 drives the optical components of the optical imaging system 111 according to an instruction of the controlling unit 150 to be described later. Also, the timing generator (TG) 113 generates an operation pulse necessary for the imaging device 112 according to an instruction of the controlling unit 150. For example, the TG 113 generates various pulses such as a 4-phase pulse for vertical transmission, a field shift pulse, a 2-phase pulse for horizontal transmission, and a shutter pulse, and supplies the same to the imaging device 112. The imaging device 112 is driven by the TG 113 to capture an object (electronic shutter function). Also, the TG 113 adjusts a shutter speed of the imaging device 112 to control the exposure of a captured image.

The image signal output by the imaging device 112 is input to the signal processing unit 120. The signal processing unit 120 performs predetermined signal processing with respect to the image signal output from the imaging device 112, and outputs the signal-processed image signal to the displaying unit 130 and the controlling unit 150. The signal processing unit 120 includes an analog signal processing unit 121, an analog/digital (A/D) converting unit 122, and a digital signal processing unit 123.

The analog signal processing unit 121 is a so-called analog front end that preprocesses an image signal. The analog signal processing unit 121 performs, for example, a correlated double sampling (CDS) processing, a gain processing by a programmable gain amp (PGA), or the like, with respect to the image signal output from the imaging device 112. The A/D converting unit 122 converts an analog image signal input from the analog signal processing unit 121 into a digital image signal and outputs the digital image signal to the digital signal processing unit 123. The digital signal processing unit 123 performs, for example, digital signal processing such as noise removal, white balance adjustment, color correction, edge enhancement, gamma correction, or the like, with respect to an input digital image signal, and outputs the processing result to the displaying unit 130, the controlling unit 150, or the like.

The displaying unit 130 includes, for example, a flat panel display device such as a Liquid Crystal Display (LCD) and an organic EL display. Under the control of the controlling unit 150, the displaying unit 130 displays a variety of input image data. For example, the displaying unit 130 displays a captured image (through image) input in real time from the signal processing unit 120 during an imaging . Accordingly, a user may operate the imaging apparatus 10 while viewing a through image that is being captured by the imaging device 10. Also, when a captured image recorded on the recording medium 140 is reproduced, the displaying unit 130 displays the reproduced image. Accordingly, the user may confirm the content of the captured image recorded on the recording medium 140.

The recording medium 140 stores various data such as the captured image data and metadata thereof. The recording medium 140 may use, for example, a semiconductor memory such as a memory card, or a disc-type recording medium such as an optical disc or a hard disc. In addition, the optical disc includes, for example, a Blu-ray Disc, a Digital Versatile Disc (DVD), a Compact Disc (CD), or the like. In addition, the recording medium 140 may be embedded in the imaging apparatus 10, or may be a removable medium detachable from the imaging apparatus 10.

The controlling unit 150 includes a micro controller or the like, and controls an overall operation of the imaging apparatus 10. The controlling unit 150 includes, for example, a CPU 151, an EEPROM 152, a Read Only Memory (ROM) 153, and a Random Access Memory (RAM) 154. In addition, EEPROM is the abbreviation for Electrically Erasable Programmable ROM.

A program for performing various control processes in the CPU 151 is stored in the ROM 153 of the controlling unit 150. The CPU 151 operates based on the program, and uses the RAM 154 to perform operation and control processes necessary for the respective controls. The program may be prestored in a storage device embedded in the imaging apparatus 10 (for example, the EEPROM 152, the ROM 153, and the like). Also, the program may be stored in a removable storage medium such as a disc-type recording medium or a memory card, may be provided to the imaging apparatus 10, and may be downloaded to the imaging apparatus 10 through a network such as a LAN or the Internet.

Herein, a specific example of the control by the controlling unit 150 will be described. The controlling unit 150 controls the TG 113 and the optical component driving unit 114 of the imaging unit 110 to control imaging processing of the imaging unit 110. For example, the controlling unit 150 performs automatic exposure control by adjustment of the diaphragm of the optical imaging system 111, setting of the electronic shutter speed of the imaging device 112, setting of the AGC gain of the analog signal processing unit 121, or the like (AE function). Also, the controlling unit 150 moves the focus lens of the optical imaging system 111 and changes a focus position to perform automatic focus control to automatically adapt the focus of the optical imaging system 111 with respect to a specific object (AF function). Also, the controlling unit 150 moves the zoom lens of the optical imaging system 111 and changes a zoom position to control a view angle of a captured image. Also, the controlling unit 150 records various data such as a captured image and metadata on the recording medium 140, and also reads and reproduces data recorded on the recording medium 140. In addition, the controlling unit 150 generates various display images to be displayed on the displaying unit 130, and controls the displaying unit 130 to display the display images.

The operating unit 160 and the displaying unit 130 function as a user interface. The operating unit 160 includes, for example, various operation keys such as buttons and levers, a touch panel, or the like, and outputs instruction information to the controlling unit 150 according to a user's operation.

The geomagnetic sensor 170 and the acceleration sensor 172 constitute an electronic compass for detecting an imaging azimuth (azimuth sensor). Herein, the imaging azimuth is a horizontal azimuth of an imaging direction in which an object is captured by the imaging apparatus 10. The imaging azimuth may be represented by, for example, an azimuth angle θ(θ=0° to 360°)with respect to a reference azimuth (for example, north). Also, the imaging direction may be an optical axis direction of the optical imaging system 111. In a general digital camera, the imaging direction is the front direction of the imaging apparatus 10, which corresponds to the back direction of a display screen of the displaying unit 130.

The geomagnetic sensor 170 includes, for example, a biaxial geomagnetic sensor or a triaxial geomagnetic sensor, and detects geomagnetism in a place at which the imaging apparatus 10 is present. The biaxial geomagnetic sensor detects geomagnetism of the front-back direction and geomagnetism of the horizontal direction of the imaging apparatus 10, and the triaxial geomagnetic sensor detects geomagnetism of the front-back direction, the horizontal direction, and the vertical direction of the imaging apparatus 10. The geomagnetic sensor 170 outputs geomagnetic information representing the detected geomagnetism to the controlling unit 150.

The acceleration sensor 172 detects acceleration acting on the imaging apparatus 10. The acceleration sensor 172 includes, for example, a triaxial acceleration sensor detecting acceleration of the front-back direction, the horizontal direction, and the vertical direction of the imaging apparatus 10, and detects acceleration of triaxial directions acting on the imaging apparatus 10. The acceleration sensor 172 outputs acceleration information representing the detected triaxial acceleration to the controlling unit 150. The controlling unit 150 uses the detection value of the geomagnetic sensor 170 (geomagnetic information) and the detection value of the acceleration sensor 172 (acceleration information) to calculate an attitude and an imaging azimuth of the imaging apparatus 10. This calculation method will be described later in detail.
[1.2. Functional Configuration of Imaging Apparatus]

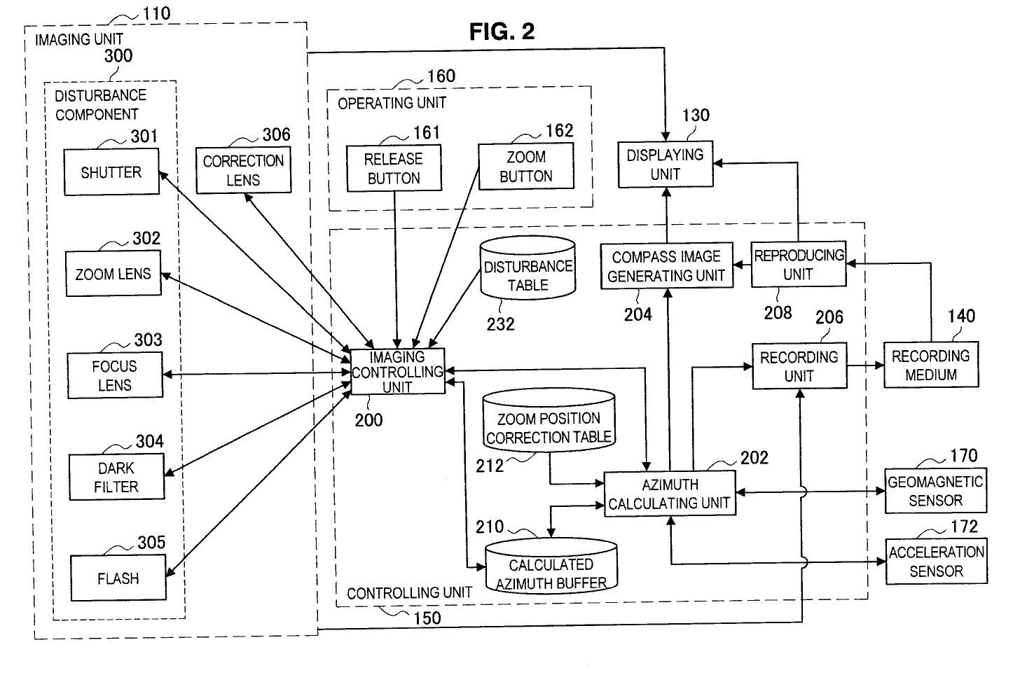

Next, a functional configuration of main units of the imaging apparatus 10 and a processing thereof according to the first embodiment of the present invention will be described with reference to FIG. 2. FIG. 2 is a block diagram illustrating a functional configuration of the imaging apparatus 10 according to the first embodiment of the present invention.

As illustrated in FIG. 2, the controlling unit 150 of the imaging apparatus 10 includes an imaging controlling unit 200, an azimuth calculating unit 202, a compass image generating unit 204, a recording unit 206, and a reproducing unit 208. These functional units are realized by executing the program stored in the ROM 153 and the like by the CPU 151 illustrated in FIG. 1. However, the present invention is not limited to such an example, and the functional units may be realized by dedicated hardware.
[1.2.1. Imaging Azimuth Calculation Processing]

First, a processing for calculating an imaging azimuth of the imaging apparatus 10 by the azimuth calculating unit 202 will be described. The azimuth calculating unit 202, the geomagnetic sensor 170, and the acceleration sensor 172 (azimuth sensor) described above constitute an electronic compass that positions an imaging azimuth. The azimuth calculating unit 202 calculates an imaging azimuth based on a detection value of the geomagnetic sensor 170 and a detection value of the acceleration sensor 172.

As described above, the geomagnetic sensor 170 detects geomagnetism in a place at which the imaging apparatus 10 is present, and outputs geomagnetic information as a detection value. Also, the acceleration sensor 172 detects acceleration of triaxial directions acting on the imaging apparatus 10, and outputs acceleration information as a detection value. The acceleration information detected by the acceleration sensor 172 may be used to detect an attitude (for example, static attitude) of the imaging apparatus 10. That is, when the imaging apparatus 10 is in a static attitude, the acceleration acting on the imaging apparatus 10 is gravitational acceleration from the Earth. Accordingly, when the direction of gravitational acceleration acting on the imaging apparatus 10 in a three-dimensional space is calculated based on the acceleration information of triaxial directions detected by the acceleration sensor 172, the attitude of the imaging apparatus 10 is detected. The attitude of the imaging apparatus 10 is represented by the tilt of the imaging apparatus 10 with respect to the ground surface (for example, rotation angles of a roll direction, a pitch direction, and a yaw direction).

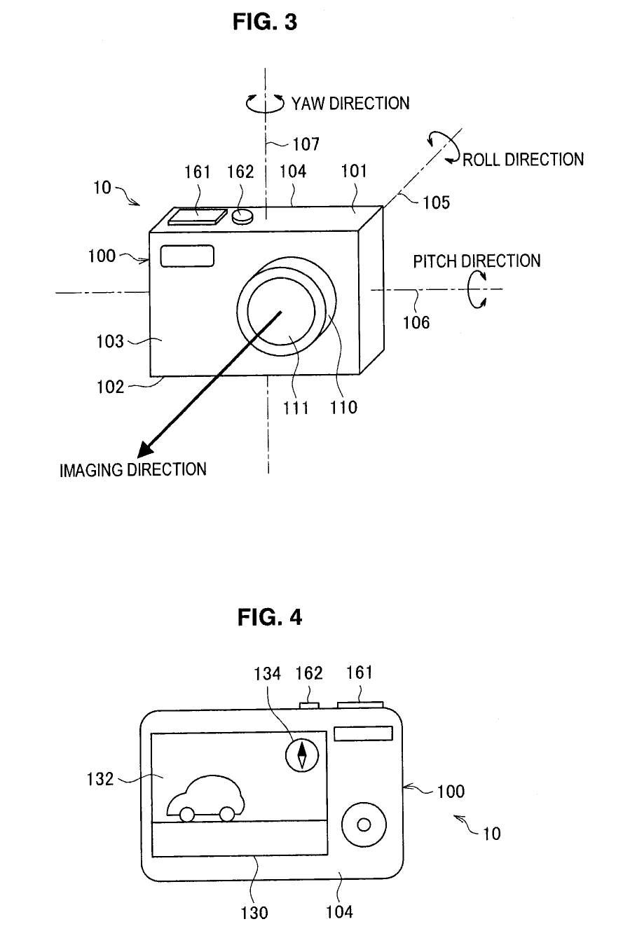

Herein, the attitude of the imaging apparatus 10 will be described in detail with reference to FIG. 3. FIG. 3 is a perspective view illustrating the imaging direction and attitude of the imaging apparatus 10 according to the first embodiment of the present invention.

The imaging apparatus 10 includes, for example, a rectangular housing 100 that has a top side 101 and a bottom side 102 that are parallel to each other. The optical imaging system 111 of the imaging unit 110 is installed on a front side 103 of the housing 100, and a display screen (not illustrated) of the displaying unit 130 is installed on a rear side 104 of the housing 100. A roll axis 105 is a rotation axis extending in the front-back direction of the housing 100, and the imaging apparatus 10 rotates around the roll axis 105 in the roll direction and is tilted right and left with respect to the ground surface. Likewise, a pitch axis 106 is a rotation axis extending in the horizontal direction of the housing 100, and the imaging apparatus 10 rotates around the pitch axis 106 in the pitch direction and is tilted back and forth with respect to the ground surface. Also, a yaw axis 107 is a rotation axis extending in the vertical direction of the housing 100, and the imaging apparatus 10 rotates around the yaw axis 107 in the yaw direction and changes an imaging direction.

As described above, the attitude of the imaging apparatus 10 may be represented by rotation angles (roll angle α, pitch angle β, and yaw angle γ) at which the imaging apparatus 10 has rotated in the roll direction, the pitch direction, and the yaw direction with respect to the ground surface. In addition, the roll axis 105 is in the same direction as the imaging direction of the imaging apparatus 10. Also, when the imaging apparatus 10 rotates in the yaw direction, since the front horizontal direction of the imaging apparatus 10 changes, the imaging azimuth (horizontal azimuth of the imaging direction) also changes.

Also, when the rotation angles of the imaging apparatus 10 in the roll direction, the pitch direction, and the yaw direction (tilt angles with respect to the ground surface) are detected by the acceleration sensor 172, a correct imaging azimuth may be obtained by subtracting the relevant rotation angle from the detection value of the geomagnetic sensor 170 and calculating geomagnetism in the horizontal direction. In addition, even when a uniaxial or biaxial acceleration sensor is used, a rotation angle of one or two directions of the imaging apparatus 10 may be detected and thus an imaging azimuth may be calculated. However, when a triaxial acceleration sensor is used, an imaging azimuth may be calculated more accurately.

Returning to FIG. 2, a description of an imaging azimuth calculation processing by the azimuth calculating unit 202 will be continued. The azimuth calculating unit 202 calculates an attitude of the imaging apparatus 10 with respect to the ground surface, based on a detection value of the acceleration sensor 172. The attitude of the imaging apparatus 10 may be represented by, for example, the rotation angles (roll angle α, pitch angle β, and yaw angle γ) of the imaging apparatus 10 described above. In addition, the azimuth calculating unit 202 calculates an attitude of the geomagnetic sensor 170 from the prestored geomagnetic sensor installation information and the attitude information of the imaging apparatus 10 calculated above. Herein, the geomagnetic sensor installation information is information representing the installation attitude of the geomagnetic sensor 170 installed in the imaging apparatus 10 (direction of the geomagnetic sensor 170 with respect to the imaging apparatus 10). The installation attitude of the geomagnetic sensor 170 is known in a manufacturing process of the imaging apparatus 10. The azimuth calculating unit 202 adds the attitude (roll angle α, pitch angle β, and yaw angle γ) of the imaging apparatus 10 with respect to the ground surface to the installation attitude (default rotation angle) of the geomagnetic sensor 170, thereby obtaining the attitude of the geomagnetic sensor 170 with respect to the ground surface.

In addition, the azimuth calculating unit 202 extracts a horizontal vector of geomagnetism from the detection value of the geomagnetic sensor 170 and the attitude information of the geomagnetic sensor 170 calculated above, and calculates a reference azimuth (for example, north). Also, the azimuth calculating unit 202 calculates a horizontal vector of an optical axis direction (that is, imaging direction) of the optical imaging system 111 from prestored optical system installation information and precalculated attitude information of the imaging apparatus 10. Herein, the optical system installation information is information representing the installation attitude of the optical imaging system 111 installed in the imaging apparatus 10 (direction of the optical axis of the optical imaging system 111 with respect to the imaging apparatus 10). The optical system installation information is also known in the manufacturing process of the imaging apparatus 10. The azimuth calculating unit 202 obtains the horizontal azimuth of the imaging direction (that is, imaging azimuth) from the difference between the vector of the reference azimuth calculated above and the horizontal vector of the imaging direction. For example, the azimuth calculating unit 202 obtains an azimuth angle θ(θ=0° to 360°) with respect to the reference azimuth (for example, north), as the imaging azimuth.

The imaging azimuth as the azimuth of the imaging direction of the imaging apparatus 10 may be calculated by the above calculation processing of the azimuth calculating unit 202. In addition, even when the user rotates the imaging apparatus 10 by 90° in the roll direction in order to take a vertical photograph, the azimuth calculating unit 202 may calculate a correct imaging azimuth because the horizontal vector of the imaging direction has been calculated.
[1.2.2. Imaging Azimuth Displaying Processing]

Next, a processing for displaying, by the compass image generating unit 204 and the displaying unit 130, a compass image 134 representing an imaging azimuth will be described with reference to FIGS. 2 and 4.

The azimuth calculating unit 202 transmits information representing the above-calculated imaging azimuth (for example, value of the azimuth angle θ), to the compass image generating unit 204. The compass image generating unit 204 generates a compass image 134 to be displayed on the displaying unit 130, based on the information representing the imaging azimuth. For example, the compass image generating unit 204 generates the compass image 134 indicating that the imaging azimuth (azimuth angle θ) is the upward direction of the display screen. The compass image generating unit 204 outputs data of the generated compass image 134 to the displaying unit 130.

As illustrated in FIG. 4, based on an instruction from the controlling unit 150, the displaying unit 130 overlappingly displays the compass image 134 representing the imaging azimuth (azimuth angle θ) detected by the azimuth calculating unit 202, on a captured image 132 (through image) input from the imaging unit 110. From the viewpoint of the user, the compass image 134 is displayed to indicate that the imaging azimuth (azimuth angle θ) calculated by the azimuth calculating unit 202 is the upward direction with respect to the ground surface. By the display of the compass image 134, the user may capture an image while checking the imaging azimuth of the captured image 132.
[1.2.3. Imaging Processing]

Next, referring again to FIG. 2, a processing for generating a captured image (picture) by capturing an object according to an imaging start instruction input to the imaging apparatus 10 (imaging processing) will be described.

When an imaging start instruction is input, the imaging apparatus 10 captures an object by the imaging unit 110 to generate a captured image, and simultaneously calculates an imaging azimuth at this imaging timing by the azimuth calculating unit 202. An example of inputting an imaging start instruction to the imaging apparatus 10 by pressing down a release button 161 by the user of the imaging apparatus 10 will be described below.

As illustrated in FIG. 2, the imaging controlling unit 200 controls a plurality of components constituting the imaging unit 110 to cause the imaging unit 110 to perform imaging processing. The components of the imaging unit 110 includes, for example, a shutter 301, a zoom lens 302, a focus lens 303, a dark filter 304, a flash 305, a correction lens 306, and the imaging device 112 (see FIG. 1), or the like. Among these, the shutter 301, the zoom lens 302, the focus lens 303, the dark filter 304, and the correction lens 306 are optical components included in the optical imaging system 111.

The imaging controlling unit 200 uses the optical component driving unit 114, the TG 113 (see FIG. 1), or the like to control the operations of the components of the imaging unit 110. For example, the imaging controlling unit 200 controls the optical component driving unit 114 to operate the optical components of the optical imaging system 111. Also, the imaging controlling unit 200 controls the TG 113 to operate the imaging device 112. The imaging controlling unit 200 controls the operations of the components of the imaging unit 110 automatically or according to a user's operation, to cause the imaging unit 110 to perform imaging processing.

For example, according to a user's operation on the zoom button 162, the imaging controlling unit 200 moves the position of the zoom lens 302 to adjust a view angle of a captured image. Also, in order to realize an auto focus function, the imaging controlling unit 200 moves the position of the focus lens 303 based on the image processing result with respect to the captured image. Accordingly, by adjusting the focus position, the focus of the optical imaging system 111 is focused on a desired object. Also, based on the luminance of the captured image, the imaging controlling unit 200 drives the dark filter 304 to adjust the exposure of the captured image. Also, according to the brightness of an ambient environment, the imaging controlling unit 200 triggers the flash 305 to irradiate light onto an object. Also, in order to realize a camera shake correcting function, the imaging controlling unit 200 drives the correction lens 306 based on the detection value of the acceleration sensor 172. Accordingly, the correction lens 306 may correct a relevant camera shake by a minute rotation according to a camera shake acting on the imaging apparatus 10.

When the imaging apparatus 10 is used to capture and record a capture image (picture), the user performs an operation ( ) of pressing down (half press or full press) the release button 161 of the imaging apparatus 10. According to a half press operation by the user, the release button 161 outputs an imaging start instruction to the controlling unit 150. Also, according to a full press operation by the user, the release button 161 outputs an imaging execution instruction to the controlling unit 150. In addition, although an example of inputting the imaging start instruction to the controlling unit 150 according to a user's operation on the release button 161 is described herein, the controlling unit 150 may generate the imaging start instruction automatically by a self timer function of the imaging apparatus 10.

According to the imaging start instruction and the imaging execution instruction input from the release button 161, the imaging controlling unit 200 controls an operation of each component of the imaging unit 110 to cause the imaging unit 110 to perform imaging processing. That is, the imaging controlling unit 200 operates the components of the imaging unit 110, for example, the shutter 301, the focus lens 303, the dark filter 304, the flash 305, the correction lens 306, the imaging device 112, or the like, captures an object image incident through the optical imaging system 111 with the imaging device 112, and generates a captured image.

Specifically, first, when the user operates the zoom button 162 before operating the release button 161, a zoom instruction is input from the zoom button 162 to the imaging controlling unit 200. According to the zoom instruction, the imaging controlling unit 200 moves the position of the zoom lens 302 to adjust the zoom position (view angle) of the captured image.

Next, when the user half-presses the release button 161, an imaging start instruction is input from the release button 161 to the imaging controlling unit 200. According to the input of the imaging start instruction, the imaging controlling unit 200 controls the imaging unit 110 to perform an imaging preparation processing. The imaging preparation processing is, for example, a focus control performed by using the focus lens 303, an exposure control performed by using the dark filter 304, or the like. Also, when the user fully presses the release button 161 directly, the same operation as in the case of the half press operation is performed.

Thereafter, when the user fully presses the release button 161, an imaging execution instruction is input from the release button 161 to the imaging controlling unit 200. According to the input of the imaging execution instruction, the imaging controlling unit 200 controls the imaging unit 110 to perform an imaging execution processing for generating a captured image to be recorded. The imaging execution processing is, for example, opening/closing of the shutter 301, light emission of the flash 305, capture processing of a captured image by the imaging device 112 (for example, exposure of the capturing surface of the imaging device 112, and readout of the captured image from the imaging device 112), or the like.

As described above, according to the imaging start instruction, the imaging controlling unit 200 controls the imaging unit 110 to cause the imaging unit 110 to perform imaging processing. In this manner, the imaging processing is a processing for generating a captured image by capturing an object by the imaging unit 110 according to the imaging start instruction. The imaging processing includes the imaging preparation processing and the imaging execution processing. Also, the imaging processing period is the execution period of the imaging processing, and is, for example, the period from an input time point of the imaging start instruction (for example, a time point of a half press operation on the release button 161) to an output time point of the captured image from the imaging device 112.
[1.2.4. Azimuth Calculation Processing in Imaging Processing Period]

Next, a processing for calculating an imaging azimuth to be recorded as additional information of a captured image based on the geomagnetic information detected in the imaging processing period will be described.

In the above-described imaging processing period, a plurality of components of the imaging unit 110 are operated in combination. These components include a magnetic field generating component that generates a magnetic field therearound by an electric motor such as a motor. When operated, the magnetic field generating component generates a magnetic field that affects the detection result of the geomagnetic sensor 170. The geomagnetic sensor 170 detecting weak geomagnetism also detects the magnetic field generated by the magnetic field generating component as a disturbance. Therefore, when a disturbance magnetic field is generated around the geomagnetic sensor 170 by the magnetic field generating component, the geomagnetic sensor 170 may not accurately detect geomagnetism, and an error may occur in the detection value of the geomagnetic sensor 170. In this case, the detection error of the geomagnetic sensor 170 increases as the strength of the magnetic field generated by the magnetic field generating component increases.

Hereinafter, among the components of the imaging unit 110, the magnetic field generating component generating a magnetic field acting as a disturbance on the geomagnetic sensor 170 will be referred to as a disturbance component 300. As illustrated in FIG. 2, the disturbance component 300 is, for example, the shutter 301, the zoom lens 302, the focus lens 303, the dark filter 304, the flash 305, or the like of the imaging unit 110. During the imaging processing, when the shutter 301 is operated in order to expose the imaging surface of the imaging device 112, a magnetic field is generated from the shutter 301 and a driving mechanism thereof. In addition, a magnetic field is also generated when the flash 305 emits light. Also, when the zoom lens 302 is moved in order to change a zoom position or the focus lens 303 is moved in order to focus the focus of the optical imaging system 111 on an object, a magnetic filed is generated from a driving mechanism (motor or the like) of the lenses. Likewise, when the dark filter 304 is driven in order to perform exposure adjustment, a magnetic field is generated from the driving mechanism thereof.

In this manner, the disturbance component 300 of the imaging unit 110 operates during the imaging processing to generate a disturbance magnetic field causing a detection error of the geomagnetic sensor 170. However, the disturbance component 300 does not always operate during the imaging processing, and does not generate a disturbance magnetic field when stopping its operation. Accordingly, an error does not occur in the detection value of the geomagnetic sensor 170 in an operation stop period of the disturbance component 300 during the imaging processing period.

However, in the imaging processing period corresponding to a release operation, the plurality of disturbance components 300 operate, and the respective disturbance components 300 operate instantaneously at different timings. In addition, since the disturbance components 300 do not exclusively operate, the disturbances generated by the plurality of disturbance components 300 need to be cancelled in combination. Accordingly, it is difficult to suitably correct the detection value of the geomagnetic sensor 170 with respect to all of the disturbances from the disturbance components 300 in a limited short period (for example, less than one second) corresponding to the imaging processing period. On the other hand, it may be impossible to obtain an imaging azimuth and correctly detect an imaging azimuth, based on the geomagnetic data detected at the timing deviating from the imaging processing period.

Because of the above situation, it is an important point whether effective geomagnetic data can be detected within the imaging processing period corresponding to the imaging timing. Therefore, the imaging apparatus 10 according to the first embodiment of the present invention is characterized in that the imaging controlling unit 200 and the azimuth calculating unit 202 cooperate with each other to determine a period in which the disturbance component 300 does not operate during the imaging processing period (operation stop period) and to calculate an imaging azimuth by using the geomagnetic data detected in the operation stop period. In this manner, since the geomagnetic sensor 170 can accurately detect geomagnetism in the state in which there is no disturbance from the disturbance component 300, the azimuth calculating unit 202 can correctly obtain an imaging azimuth at the timing at which the release lens 161 is pressed down. An imaging azimuth calculation processing during the imaging processing period will be described below in detail.

As described above, in the imaging processing period, the azimuth calculating unit 202 calculates an imaging azimuth based on the detection value of the geomagnetic sensor 170 (geomagnetic information) and the detection value of the acceleration sensor 172 (acceleration information) and records (buffers) the calculated imaging azimuth data in a calculated azimuth buffer 210. The calculated azimuth buffer 210 is an example of an azimuth storing unit, and temporarily stores the imaging azimuth information calculated by the azimuth calculating unit 202. The azimuth calculating unit 202 performs the imaging azimuth calculation processing during the imaging processing period, for example, at intervals of predetermined time periods or at certain timings, and sequentially records a plurality of imaging azimuth data obtained from the result in the calculated azimuth buffer 210. Accordingly, it may be possible to calculate a plurality of imaging azimuths at different timings during the imaging processing period and to compensate for a geomagnetism detection error and an imaging azimuth calculation error.

Also, according to the position of the zoom lens 302, an error occurs in the detection value of the geomagnetic sensor 170. Thus, the azimuth calculating unit 202 uses a zoom position correction table 212 to correct an imaging azimuth according to the position of the zoom lens 302.

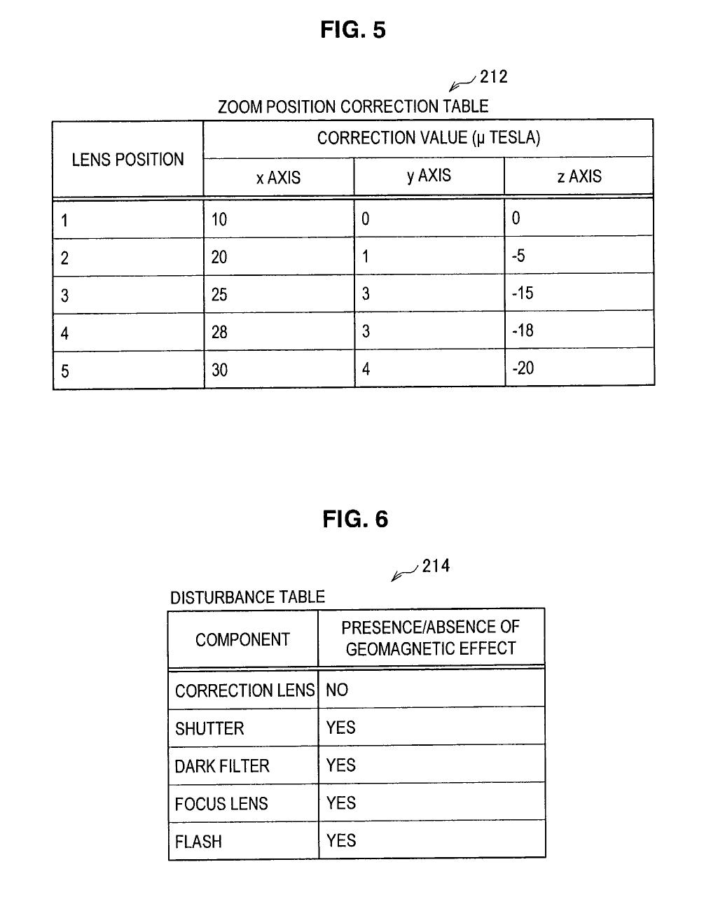

FIG. 5 is a diagram illustrating a zoom position correction table 212 retained by the controlling unit 150 according to the first embodiment of the present invention. As illustrated in FIG. 5, the zoom position correction table 212 associates the position of the zoom lens 302 (zoom position) with the correction value with respect to the detection value of the geomagnetic sensor 170 (for example, x-axis/y-axis/z-axis detection value of the geomagnetic sensor 170). The correction value is, for example, a magnetic flux density (μtesla) of magnetism generated by the position of the zoom lens 302, and is predetermined by a test or the like. In this manner, the zoom position correction table 212 retains correction value information for correcting an imaging azimuth according to the position of the zoom lens 302.

Before the imaging processing, in a step of fixing the position of the zoom lens 302, the imaging controlling unit 200 notifies the azimuth calculating unit 202 of the position of the zoom lens 302. During the imaging processing period, the azimuth calculating unit 202 acquires a correction value corresponding to the position of the zoom lens 302 with reference to the zoom position correction table 212, corrects the detection value of the geomagnetic sensor 170 by using the correction value, and calculates an imaging azimuth by using the corrected detection value. In another embodiment, after calculating the imaging azimuth by using the detection value of the geomagnetic sensor 170, the azimuth calculating unit 202 may correct the calculated imaging azimuth by using the correction value of the zoom position correction table 212. By the imaging processing, the imaging azimuth may be corrected suitably according to the position of the zoom lens 302 at the time of the imaging processing.

Next, a processing for controlling, by the imaging controlling unit 200, an imaging azimuth calculation processing of the azimuth calculating unit 202 according to whether the disturbance component 300 is operated will be described. With reference to a disturbance table 214, the imaging controlling unit 200 specifies the disturbance component 300 among the components of the imaging unit 110. Then, in the operation period of the selected disturbance component 300, the imaging controlling unit 200 stops the imaging azimuth calculation processing of the azimuth calculating unit 202.

FIG. 6 is a diagram illustrating a disturbance table 214 retained by the controlling unit 150 according to the first embodiment of the present invention. As illustrated in FIG. 6, the disturbance table 214 associates identification information of the components (including the disturbance components 300) of the imaging unit 110 controlled by the imaging controlling unit 200 with information indicating whether the relevant components affect geomagnetism. From an example of FIG. 6, it can be seen that the correction lens 306 is not the disturbance component 300 because it does not affect geomagnetism. On the other hand, it can be seen that the shutter 301, the dark filter 304, the focus lens 303, and the flash 305 are the disturbance components 300 because they affect geomagnetism. In this manner, the disturbance table 214 retains identification information for specifying the disturbance component 300 (magnetism generating component) among the components of the imaging unit 110.

With reference to the disturbance table 214, the imaging controlling unit 200 may specify the disturbance component 300 among the components of the imaging unit 110. Also, the imaging controlling unit 200 may also detect the operation start time and the operation end time of each of the components during the imaging processing period because it controls the operations of the components of the imaging unit 110. Accordingly, the imaging controlling unit 200 may detect the operation period of the disturbance component 300 (operation period of the magnetism generating component) in the imaging processing period. In addition, the operation period of the disturbance component 300 is the period from the operation start time point to the operation end time point of the disturbance component 300.

The imaging controlling unit 200 stops an imaging azimuth calculation processing of the azimuth calculating unit 202 in the operation period of the disturbance component 300 during the imaging processing period, and performs an imaging azimuth calculation processing by the azimuth calculating unit 202 in the operation stop period of the disturbance component 300.

Specifically, when imaging processing is started by the imaging unit 110 according to the imaging start instruction, the imaging controlling unit 200 instructs the azimuth calculating unit 202 to start positioning of an imaging azimuth. Next, when an operation of any disturbance component 300 is started during the imaging processing period, the imaging controlling unit 200 instructs the azimuth calculating unit 202 to stop the positioning of an imaging azimuth. Thereafter, when the operation of the disturbance component 300 is ended, the imaging controlling unit 200 instructs the azimuth calculating unit 202 to restart the positioning of an imaging azimuth. In this manner, the imaging controlling unit 200 repeats the positioning stop instruction and the positioning restart instruction until the imaging processing is ended. Thereafter, when the imaging processing is ended (for example, when the readout of a captured image from the imaging device 112 is completed), the imaging controlling unit 200 instructs the azimuth calculating unit 202 to end the positioning of an imaging azimuth.

By the control of the imaging controlling unit 200 as described above, the azimuth calculating unit 202 sequentially calculates an imaging azimuth only in the period from the positioning start time to the positioning end time instructed by the imaging controlling unit 200 (that is, the operation stop period of the disturbance component 300) during the imaging processing period. Then, the azimuth calculating unit 202 sequentially records data of the plurality of calculated imaging azimuths in the calculated azimuth buffer 210.

Thereafter, when the imaging processing is ended, the azimuth calculating unit 202 reads out a plurality of imaging azimuth data stored in the calculated azimuth buffer 210, and calculates an average value of the plurality of imaging azimuths. At this time, the azimuth calculating unit 202 may calculate a simple average of a plurality of imaging azimuth data stored in the calculated azimuth buffer 210 as the average value of the imaging azimuths, and may perform averaging excepting the maximum value, the minimum value, and abnormal values. Then, the azimuth calculating unit 202 outputs the calculated imaging azimuth average value as a final imaging azimuth to the recording unit 206.
[1.2.5. Captured Image and Imaging Azimuth Recording Processing]

Next, a processing for recording, by the recording unit 206, an imaging azimuth calculated by the azimuth calculating unit 202 as the additional information of a captured image will be described.

The captured image generated by the above-described imaging processing is processed by the signal processing unit 120 (see FIG. 1), and then is recorded on the recording medium 140 by the recording unit 206. When the captured image is recorded on the recording medium 140 in this manner, the azimuth calculating unit 202 outputs imaging azimuth information representing the calculated imaging azimuth average value (azimuth angle θ), to the recording unit 206.

The recording unit 206 has a function of recording additional information of the captured image (for example, Exif information) on the recording medium 140 in association with the captured image. In general, the additional information includes a variety of information related to the captured image (for example, an image size, a file format, a compression encoding scheme, or the like), imaging date/time information, a thumbnail image of a recorded image, or the like. In addition to the general information, the additional information of the captured image according to the first embodiment of the present invention includes imaging azimuth information acquired from the azimuth calculating unit 202, and attitude information of the imaging apparatus 10. The attitude information of the imaging apparatus 10 is, for example, information representing the attitude of the imaging apparatus 10 (for example, horizontal photographing, photographing by left rotation, photographing by right rotation, or the like) at the time when the captured image is recorded (release time). The attitude information is calculated from the detection value of the acceleration sensor 172 by the azimuth calculating unit 202 as described above.

According to the release instruction, the recording unit 206 compresses, encodes, and records the additional information including the imaging azimuth information acquired from the azimuth calculating unit 202, and the captured image acquired from the imaging unit 110, on the recording medium 140 in association with each other. Accordingly, the imaging azimuth information may be recorded as the additional information of the captured image (for example, azimuth angle θ) in association with the captured image. This information is useful in reproducing and displaying the captured information.

In addition, the still image capturing and recording processing has been described above. On the other hand, also in a moving image capturing and recording processing, during a moving image capturing and recording processing period, the imaging azimuth information and the attitude information may be periodically or frequently recorded as the additional information of the moving image on the recording medium 140 in association with the moving image.
[1.2.6. Imaging Azimuth Reproduction and Display Processing]

Next, a processing for reproducing, by the reproducing unit 208 and the displaying unit 130 illustrated in FIG. 2, the additional information and the captured image recorded on the recording medium 140 and displaying the same on the displaying unit 130 will be described.

According to a user's reproducing operation, the reproducing unit 208 reads and reproduces (decompresses and decodes) the captured image and the additional information thereof recorded on the recording medium 140. Then, the displaying unit 130 displays the reproduced image reproduced by the reproducing unit 208, and the compass image representing the imaging azimuth of the reproduced image.

At this time, the reproducing unit 208 determines the imaging azimuth at the time of capturing the captured image, based on the imaging azimuth information added to the captured image, and transmits information representing the imaging azimuth of the captured image (for example, azimuth angle θ) to the compass image generating unit 204. Then, according to the information representing the imaging azimuth, the compass image generating unit 204 generates a compass image to be displayed on the displaying unit 130, and outputs the compass image to the displaying unit 130. As a result, the displaying unit 130 displays the compass image acquired from the compass image generating unit 204, together with the reproduced image acquired from the reproducing unit 208. In addition, since the display state of the reproduced image and the compass image is the same as the display state of the captured image 132 and the compass image 134 illustrated in FIG. 4, an illustration thereof will be omitted.

As described above, when the captured image recorded on the recording medium 140 is reproduced, the compass image representing the azimuth at the time of capturing the captured image is displayed together with the reproduced image. Accordingly, the user may confirm the imaging azimuth at the time of capturing the image, while viewing the reproduced image.
[1.3. Imaging Azimuth Calculating and Recording Method]

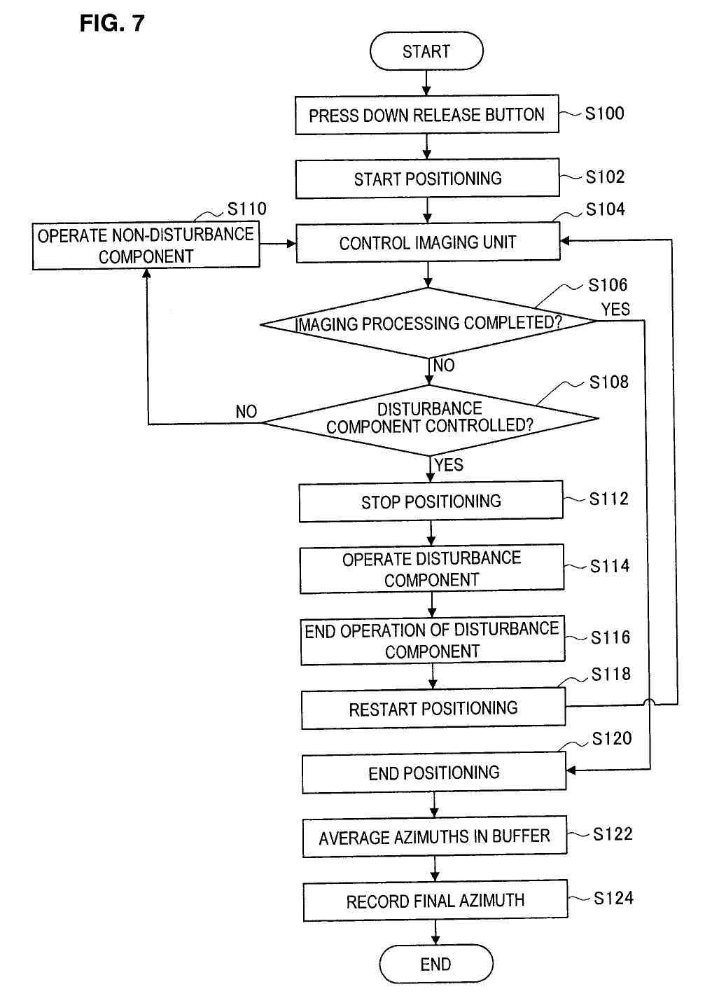

Next, an imaging azimuth calculating and recording method according to the first embodiment of the present invention will be described with reference to FIG. 7. FIG. 7 is a flow chart illustrating an imaging azimuth calculating and recording method according to the first embodiment of the present invention.

As illustrated in FIG. 7, when the user presses down the release button 161 while the imaging apparatus 10 is in an imaging standby state and displays a through image (see FIG. 3) (S100), an imaging start instruction is transmitted from the release button 161 to the imaging controlling unit 200.

In response to the imaging start instruction, the imaging controlling unit 200 starts imaging processing by the imaging unit 110, and also transmits a positioning start instruction to the azimuth calculating unit 202 (S102). In response to the positioning start instruction, the azimuth calculating unit 202 starts an imaging azimuth calculation processing, sequentially calculates an imaging azimuth based on the detection value of the geomagnetic sensor 170 and the detection value of the acceleration sensor 172, and sequentially records the calculated imaging azimuth data in the calculated azimuth buffer 210.

In the imaging processing period, the imaging controlling unit 200 controls the components of the imaging unit 110 to perform imaging processing (S104) until the imaging processing is completed (S106). At this time, based on the disturbance table 214, the imaging controlling unit 200 determines whether a control target component is the disturbance component 300 (S108). When a non-disturbance component (for example, the correction lens 306) is controlled, the imaging controlling unit 200 operates the non-disturbance component without stopping the positioning performed by the azimuth calculating unit 202 (110). In addition, the non-disturbance component is a component other than the disturbance component 300 among the components of the imaging unit 110.

On the other hand, when the disturbance component 300 (for example, the shutter 301, the focus lens 303, the dark filter 304, the flash 305, or the like) is operated during the imaging processing period, the imaging controlling unit 200 transmits a positioning stop instruction to the azimuth calculating unit 202 to stop the positioning processing of the azimuth calculating unit 202 (imaging azimuth calculation processing) (S112), and then operates the disturbance component 300 (S114).

Next, when the operation of the disturbance component 300 is ended (S116), the imaging controlling unit 200 transmits a positioning restart instruction to the azimuth calculating unit 202 to restart positioning by the azimuth calculating unit 202 (S118). As a result, the azimuth calculating unit 202 restarts an imaging calculation processing to sequentially calculate an imaging azimuth, and sequentially records the calculated imaging azimuth data in the calculated azimuth buffer 210.

In the imaging processing period, the imaging controlling unit 200 repeats the above steps S104 to S118 and stops the positioning of the azimuth calculating unit 202 whenever the disturbance component 300 is operated. In this manner, the azimuth calculating unit 202 sequentially calculates an imaging azimuth only in the period in which the disturbance component 300 is not operated during the imaging processing period (operation stop period), and sequentially records the imaging azimuth data in the calculated azimuth buffer 210.

Thereafter, when a readout of the captured image from the imaging device 112 is completed and the imaging processing is ended (S106), the imaging controlling unit 200 transmits a positioning end instruction to the azimuth calculating unit 202 and ends the positioning by the azimuth calculating unit 202 (S120).

Next, according to the end of the imaging processing, the azimuth calculating unit 202 reads out a plurality of imaging azimuth data stored in the calculated azimuth buffer 210, and calculates the average value of the imaging azimuths (S122). Thereafter, the recording unit 206 records the average value calculated by the azimuth calculating unit 202 as additional information of the captured image generated by the imaging unit 110 on the recording medium 140 (S124).

As described above, the imaging controlling unit 200 stops the positioning by the azimuth calculating unit 202 when the disturbance component 300 is operated during the imaging processing period, and restarts the positioning by the azimuth calculating unit 202 when the operation of the disturbance component 300 is ended. Accordingly, in the operation stop period of the disturbance component 300, the azimuth calculating unit 202 may calculate an imaging azimuth by using accurate geomagnetic data that is not affected by a disturbance magnetic field.
[1.4. Imaging Azimuth Calculation Timing]

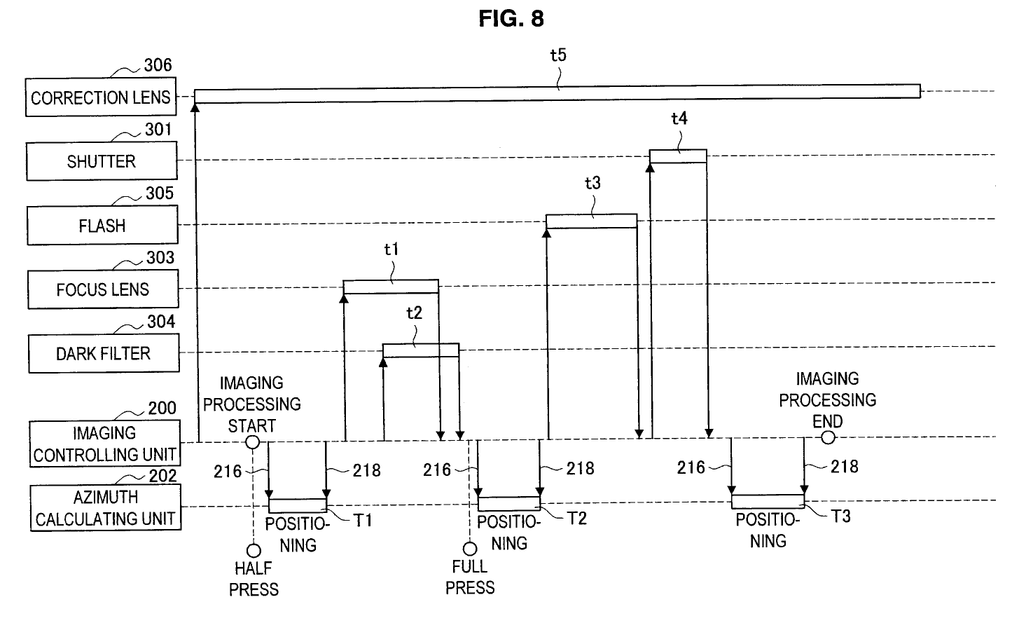

Next, the relation between an operation period of the disturbance component 300 in an imaging processing period and a positioning period by the azimuth calculating unit 202 according to the first embodiment of the present invention will be described with reference to FIG. 8. FIG. 8 is a timing chart illustrating an operation period of the disturbance component 300 and a positioning period by the azimuth calculating unit 202 according to the first embodiment of the present invention.

As illustrated in FIG. 8, in the imaging processing period from the start of imaging processing according to an imaging start instruction to the end of the imaging processing, the focus lens 303 and the dark filter 304 acting as the disturbance components 300 are operated to perform the imaging preparation processing. At this time, an operation period t1 of the focus lens 303 and an operation period t2 of the dark filter 304 partially overlap. Next, the flash 305 and the shutter 301 acting as 304 the disturbance components 300 are operated to perform the imaging execution processing. At this time, an operation period t3 of the flash 305 and an operation period t4 of the dark filter 304 do not overlap but are adjacent to each other. Also, the correction lens 306 acting as the disturbance component 300 is typically operated during the imaging processing period (operation period t5).

As illustrated in FIG. 8, even though the imaging processing period is a limited short time (for example, less than one second), a plurality of disturbance components 300 are operated in combination during the imaging processing period. Accordingly, it is difficult to correct the detection value of the geomagnetic sensor 170 in consideration of the influence of a disturbance magnetic field generated by all of the disturbance components 300. However, the imaging processing period includes the period when no disturbance component 300 is operated (operation stop period). Thus, the imaging controlling unit 200 sequentially transmits a positioning start instruction 216 and a positioning stop instruction 218 to the azimuth calculating unit 202 according to the operation start and the operation stop of each disturbance component 300 so that the azimuth calculating unit 202 is operated in the operation stop period of the disturbance component 300.

The azimuth calculating unit 202 positions an imaging azimuth only in the period from the positioning start instruction 216 to the positioning stop instruction 218 (positioning periods T1, T2 and T3), and does not position an imaging azimuth in the operation period of the other disturbance components 300. In this manner, the azimuth calculating unit 202 calculates an imaging azimuth a plurality of times by using the accurate geomagnetic data detected in the positioning periods T1, T2 and T3 when a disturbance magnetic field is not generated by the disturbance component 300, and sequentially records the processing result in the calculated azimuth buffer 210. Then, after completion of the imaging processing, the azimuth calculating unit 202 averages a plurality of imaging azimuth data accumulated in the calculated azimuth buffer 210, and records the averaging result on the recording medium 140. Accordingly, it may be possible to record an accurate imaging azimuth, which is suitable for the imaging timing of the captured image (picture) and from which the influence of a disturbance is removed, as the additional information of the captured image.
[2. Second Embodiment]

Next, an imaging apparatus and an azimuth recording method thereof according to a second embodiment of the present invention will be described. The second embodiment is different from the first embodiment in terms of an imaging azimuth calculating method, and is substantially identical to the first embodiment in terms of a functional configuration. Thus, a detailed description thereof will be omitted.

In the first embodiment, the imaging controlling unit 200 controls the positioning start and the positioning stop of the azimuth calculating unit 202 according to whether there is a disturbance component 300, and the azimuth calculating unit 202 calculates an imaging azimuth only in the operation stop period of the disturbance component 300 during the imaging processing period. On the other hand, in the second embodiment, the imaging controlling unit 200 typically calculates the imaging azimuth during the imaging processing period, and records the same in the calculated azimuth buffer 210. Then, after completion of the imaging processing, the imaging controlling unit 200 provides operation period information representing the operation period of the disturbance component 300 to the azimuth calculating unit 202. Based on the operation period information, the azimuth calculating unit 202 extracts only a plurality of imaging azimuths calculated in the operation stop period of the disturbance component 300 during the imaging processing period, from the calculated azimuth buffer 210. The azimuth calculating unit 202 averages the calculated imaging azimuths to calculate the final imaging azimuth. A processing according to the second embodiment will be described below in detail.
[2.1. Functional Configuration of Imaging Apparatus]

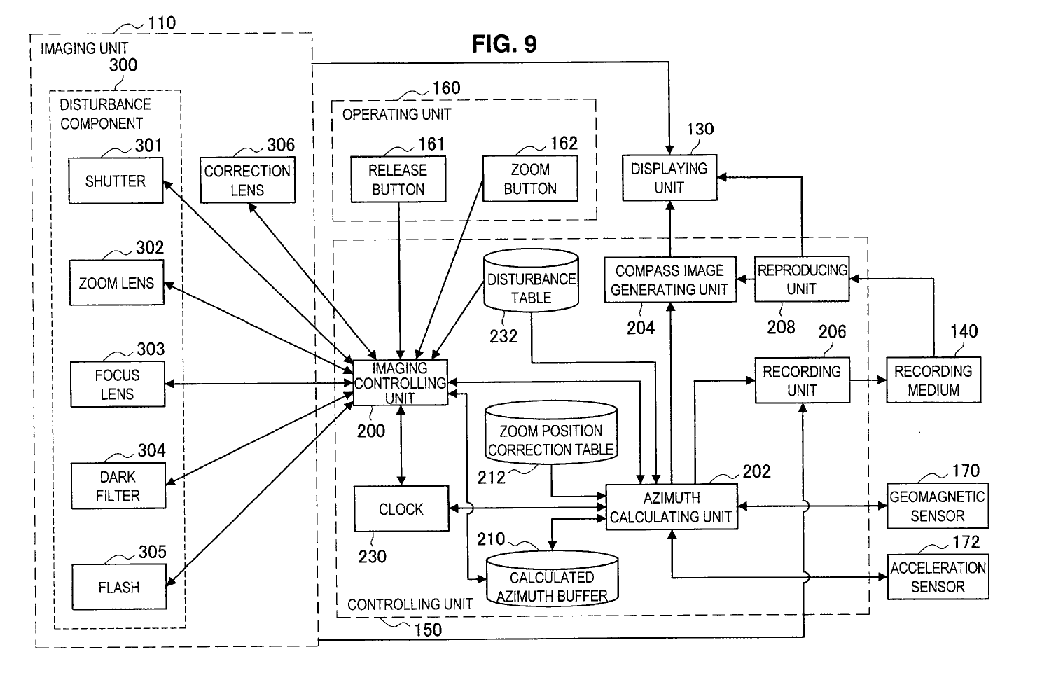

First, a functional configuration of main units of the imaging apparatus 10 and a processing thereof according to the second embodiment of the present invention will be described with reference to FIG. 9. FIG. 9 is a block diagram illustrating a functional configuration of the imaging apparatus 10 according to the second embodiment of the present invention.

As illustrated in FIG. 9, the imaging apparatus 10 according to the second embodiment includes a clock 230 in addition to the components of the imaging apparatus 10 according to the first embodiment. The clock 230 generates a clock signal for synchronization of the operation timing of each unit of the imaging apparatus 10. The clock 230 provides the clock signal to the imaging controlling unit 200 and the azimuth calculating unit 202.

When an operation of the disturbance component 300 is controlled during the imaging processing period, the imaging controlling unit 200 specifies the operation start time point and the operation end time point of the disturbance component 300 based on the clock signal obtained from the clock 230, and retains a time stamp at these time points. Then, the imaging controlling unit 200 generates operation period information representing the operation period of the disturbance component 300, from the operation start time point and the operation end time point of the disturbance component 300.

On the other hand, the azimuth calculating unit 202 sequentially calculates imaging azimuths during the imaging processing period based on the detection value of the geomagnetic sensor 170, and specifies the calculation time point of each of the plurality of imaging azimuths based on the clock signal from the clock 230. Then, the azimuth calculating unit 202 associates the plurality of calculated imaging azimuths with calculation time information representing the calculation time point of each of the imaging azimuths, and sequentially records the same in the calculated azimuth buffer 210.
[2.2. Azimuth Calculation Processing in Imaging Processing Period]

Herein, a processing for calculating an imaging azimuth to be recorded as additional information of a captured image based on the geomagnetic information detected in the imaging processing period will be described in detail.

As described in the first embodiment, in the imaging processing period, a disturbance magnetic field disturbing the detection value of the geomagnetic sensor 170 is generated by the operation of the disturbance component 300 of the imaging unit 110. Accordingly, it is important to extract any effective geomagnetic data within the imaging processing period corresponding to the imaging timing by canceling the effect of the disturbance magnetic field.

Thus, in the imaging apparatus 10 according to the second embodiment, the imaging controlling unit 200 generates operation period information representing the operation period of the disturbance component 300 during the imaging processing period, and provides the same to the azimuth calculating unit 202. Then, the azimuth calculating unit 202 extracts the imaging azimuth data calculated in the operation stop period of the disturbance component 300, among the imaging azimuth data stored in the calculated azimuth buffer 210 calculated in the imaging processing period, and calculates the average value of the imaging azimuths. Accordingly, the azimuth calculating unit 202 may correctly calculate an imaging azimuth at the imaging timing of pressing down the release button 161 by using only the data of the imaging azimuth positioned in the operation stop period of the disturbance component 300. The imaging azimuth calculation processing will be described below in detail.

In the imaging processing period, the azimuth calculating unit 202 calculates an imaging azimuth based on the above-described detection value of the geomagnetic sensor 170 (geomagnetic information) and the detection value of the acceleration sensor 172 (acceleration information) and sequentially records (buffers) the calculated imaging azimuth data in the calculated azimuth buffer 210. The azimuth calculating unit 202 performs the imaging azimuth calculation processing a plurality of times in the imaging processing period, for example, at predetermined time intervals or at certain timings, and sequentially records a plurality of resulting imaging azimuth data in the calculated azimuth buffer 210. At this time, in the same manner as in the first embodiment, the azimuth calculating unit 202 corrects the imaging azimuth according to the position of the zoom lens 302 by using the zoom position correction table 212.

On the other hand, when the components of the imaging unit 110 are controlled in the imaging processing period, the imaging controlling unit 200 may specify the disturbance component 300 among the components of the imaging unit 110 with reference to a disturbance table 232.

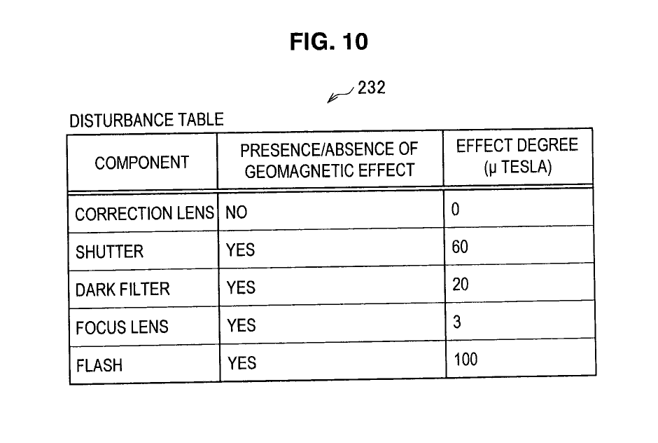

FIG. 10 is a diagram illustrating the disturbance table 232 retained by the controlling unit 150 according to the second embodiment of the present invention. As illustrated in FIG. 10, the disturbance table 232 according to the second embodiment includes influence degree information of the disturbance component 300 in addition to the information included in the disturbance table 214 (see FIG. 6) according to the first embodiment (component identification information, and geomagnetic influence presence/absence information). The influence degree information is information representing the degree of influence of the magnetic field (disturbance magnetic field) generated by the disturbance component 300 of the imaging unit 110, on the geomagnetism detected by the geomagnetic sensor 170. For example, a magnetic flux density OA tesla) representing the magnitude of a geomagnetic disturbance caused by a disturbance magnetic field may be used as the influence degree information. Herein, since the influence degree information of the disturbance table 232 represents the degree of influence on a magnetic field caused by the operation of the disturbance component 300, the influence degree information of the disturbance table 232 represents not a magnetic flux density with respect to x axis, y axis, and z axis as in the zoom position correction table 212, but an absolute value of the magnetic density.

The imaging controlling unit 200 may specify the disturbance component 300 among the components of the imaging unit 110 with reference to the disturbance table 232. Also, since the imaging controlling unit 200 controls the operation of the components of the imaging unit 110 during the imaging processing period, it may also detect the operation start time point and the operation end time point of each component. Accordingly, the imaging controlling unit 200 may generate operation period information representing the operation period of each disturbance component 300 in the imaging processing period. Also, according to the start and the end of the imaging processing by the imaging unit 110, the imaging apparatus 10 controls the positioning operation of the azimuth calculating unit 202 (imaging azimuth calculation processing). Also, when the imaging processing is completed, the imaging controlling unit 200 outputs the operation period information of the disturbance component 300 to the azimuth calculating unit 202.

Specifically, when the imaging processing of the imaging unit 110 is started according to the imaging start instruction, the imaging controlling unit 200 instructs the azimuth calculating unit 202 to start the positioning of an imaging azimuth. Next, during the imaging processing period, when controlling the operation of the disturbance component 300, the imaging controlling unit 200 detects the operation start time point and the operation end time point of the disturbance component 300 by using the clock signal from the clock 230, and generates operation period information of the disturbance component 300. Thereafter, when the imaging processing is completed, the imaging controlling unit 200 instructs the azimuth calculating unit 202 to end the positioning of an imaging azimuth, and also provides the operation period information of the disturbance component 300 to the azimuth calculating unit 202.

On the other hand, the azimuth calculating unit 202 typically calculates an imaging azimuth sequentially in the imaging processing period, and sequentially records the plurality of calculated imaging azimuth data and calculation time information representing the calculation time point of the imaging azimuth, in the calculated azimuth buffer 210.

Thereafter, when the imaging processing is completed, the azimuth calculating unit 202 receives the positioning end instruction and the operation period information of the disturbance component 300 from the imaging controlling unit 200. Then, with reference to the calculation time information on a plurality of imaging azimuth data accumulated in the calculated azimuth buffer 210, the azimuth calculating unit 202 extracts the imaging azimuth data calculated in the period other than the operation period of the disturbance component 300 during the imaging processing period (that is, the operation stop period of the disturbance component 300), among the plurality of imaging azimuth data. Then, the azimuth calculating unit 202 averages the extracted imaging azimuth data, and calculates the average value of the imaging azimuth. The azimuth calculating unit 202 outputs the average value of the imaging azimuths as the final azimuth to the recording unit 206, and records the average value of the imaging azimuths as the additional information of the captured image in the recording medium 140.
[2.3. Imaging Azimuth Calculating and Recording Method]

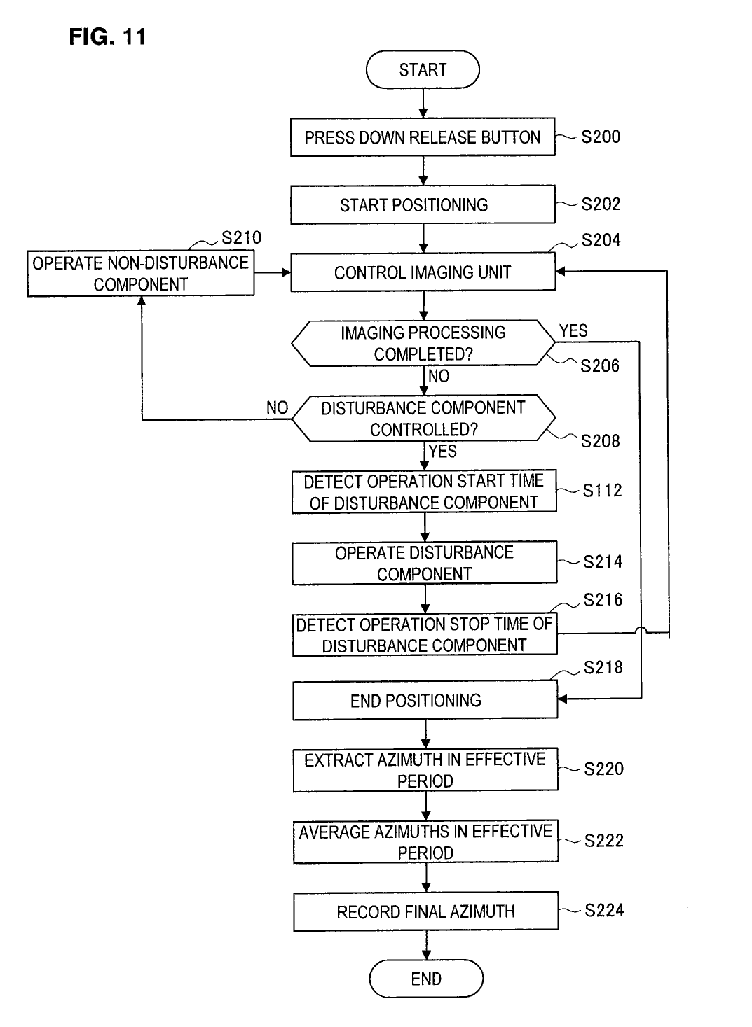

Next, an imaging azimuth calculating and recording method according to the second embodiment of the present invention will be described with reference to FIG. 11. FIG. 11 is a flow chart illustrating an imaging azimuth calculating and recording method according to the second embodiment of the present invention.

As illustrated in FIG. 11, when the imaging apparatus 10 is in an imaging standby state and displays a through image (see FIG. 3), a user instructs the imaging apparatus 10 to start imaging by pressing down the release button 161 (S200). Then, in response to the imaging start instruction input from the release button 161, the imaging controlling unit 200 starts imaging processing by the imaging unit 110, and also transmits a positioning start instruction to the azimuth calculating unit 202 (S202). In response to the azimuth calculating unit 202, the azimuth calculating unit 202 starts an imaging azimuth calculation processing, sequentially calculates an imaging azimuth based on the detection values of the geomagnetic sensor 170 and the acceleration sensor 172, and sequentially records the calculated imaging azimuth data and calculation time information representing the calculation time on the calculated azimuth buffer 210.

In the imaging processing period, the imaging controlling unit 200 controls the components of the imaging unit 110 to perform imaging processing (S204) until the imaging processing is completed (S206). At this time, based on the disturbance table 232, the imaging controlling unit 200 determines whether a control target component of the imaging unit 110 is the disturbance component 300 (S208). When a non-disturbance component (for example, the correction lens 306) is controlled, the imaging controlling unit 200 operates the non-disturbance component without recording operation period information of the non-disturbance component (S210).

On the other hand, when the disturbance component 300 (for example, the shutter 301 or the like) is controlled during the imaging processing period, the imaging controlling unit 200 detects the operation start time point of the disturbance component 300 based on a clock signal from the clock 230, and stores the same in a buffer (not illustrated) (S212). Thereafter, the imaging controlling unit 200 operates the disturbance component 300 to perform imaging processing (S214)

Next, when the operation of the disturbance component 300 is ended, the imaging controlling unit 200 detects the operation end time point of the disturbance component 300 based on a clock signal from the clock 230, and stores the same in a buffer (not illustrated) (S216)

In the imaging processing period, the imaging controlling unit 200 repeats the above steps S204 to S216 and retains operation period information (time stamp) representing the operation start time point and the operation end time point of the disturbance component 300 in the buffer whenever the disturbance component 300 is operated. On the other hand, the azimuth calculating unit 202 typically calculates an imaging azimuth sequentially during the imaging processing period, associates the imaging azimuth data with the calculation time information thereof, and sequentially records the same in the calculated azimuth buffer 210.

Thereafter, when a readout of the captured image by the imaging device 112 is completed and the imaging processing is ended (S206), the imaging controlling unit 200 transmits a positioning end instruction and the operation time information of the disturbance component 300 in the imaging processing period to the azimuth calculating unit 202, and the positioning by the azimuth calculating unit 202 is ended (S218).

Next, according to the positioning end instruction, the azimuth calculating unit 202 extracts the imaging azimuth data calculated in an effective period, among a plurality of imaging azimuth data retained in the calculated azimuth buffer 210, and averages the calculated data (S220).

Specifically, the azimuth calculating unit 202 reads out a plurality of imaging azimuth data stored in the calculated azimuth buffer 210 and calculation time information of the imaging azimuth data. Then, the azimuth calculating unit 202 matches the calculation time information of the respective imaging azimuth data and the operation period information of the disturbance component 300 acquired from the imaging controlling unit 200. Accordingly, the azimuth calculating unit 202 extracts the imaging azimuth data calculated in the operation stop period of the disturbance component 300, among the plurality of imaging azimuth data stored in the calculated azimuth buffer 210. Herein, the operation stop period of the disturbance component 300 is the period other than the operation period of the disturbance component 300 during the imaging processing period, and corresponds to the period of calculating effective imaging azimuth data for obtaining the final imaging azimuth (effective period).

Next, the azimuth calculating unit 202 averages the imaging azimuth data extracted in step S220, to calculate the average value of the imaging azimuths (S222). Thereafter, the recording unit 206 records the average value of the imaging azimuth calculated by the azimuth calculating unit 202 as additional information of the captured image generated by the imaging unit 110 on the recording medium 140 (S222).

As described above, in the imaging processing period, the azimuth calculating unit 202 continuously calculates an imaging azimuth, and stores the same in the calculated azimuth buffer 210. On the other hand, when the disturbance component 300 is operated during the imaging processing period, the imaging controlling unit 200 retains the operation period information of the disturbance component 300 and provides the operation period information to the azimuth calculating unit 202 after completion of the imaging processing. In this manner, the azimuth calculating unit 202 extracts only the imaging azimuth calculated in the operation stop period of the disturbance component 300, among all of the imaging azimuths calculated in the imaging processing period, and averages the extracted imaging azimuths. Accordingly, the azimuth calculating unit 202 may obtain the average value of imaging azimuths positioned in the operation stop period of the disturbance component 300. p0 [2.4. Imaging Azimuth Calculation Timing]

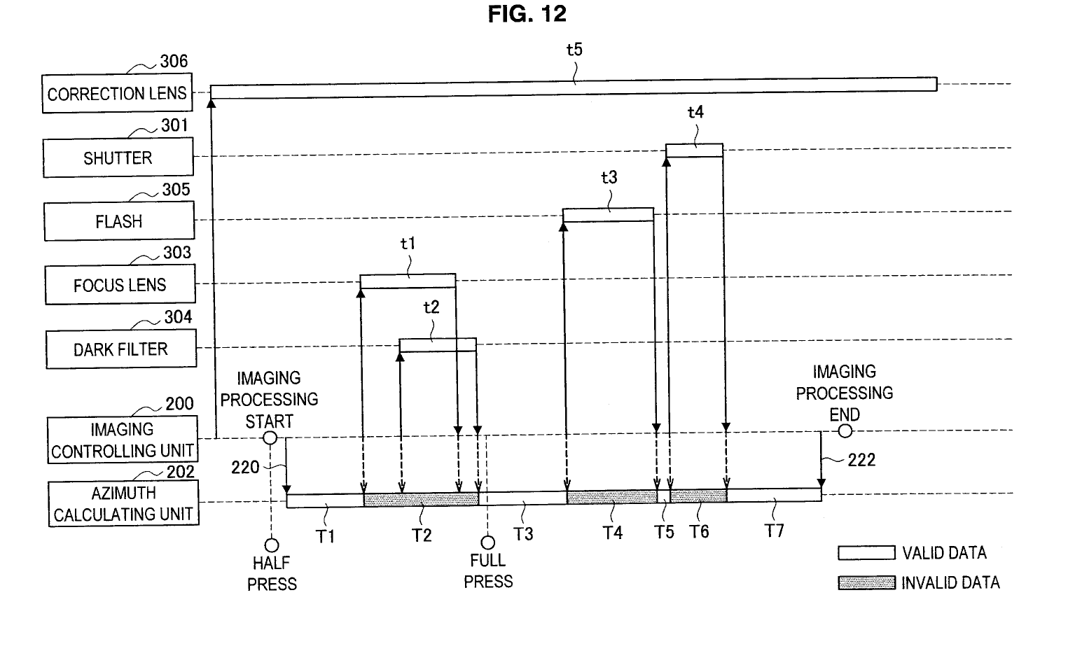

Next, the relation between an operation period of the disturbance component 300 in an imaging processing period and an effective period for calculation of an imaging azimuth by the azimuth calculating unit 202 according to the second embodiment of the present invention will be described with reference to FIG. 12. FIG. 12 is a timing chart illustrating an operation period of the disturbance component 300 and an effective period for azimuth calculation according to the second embodiment of the present invention.

As illustrated in FIG. 12, in the imaging processing period, the imaging controlling unit 200 frequently controls the components of the imaging unit 110 to perform imaging processing. At this time, the imaging controlling unit 200 transmits a positioning start instruction 220 to the azimuth calculating unit 202 when the imaging processing is started, and transmits a positioning stop instruction 222 to the azimuth calculating unit 202 when the imaging processing is ended. During periods T1 to T7 from the time of receiving the positioning start instruction 220 from the imaging controlling unit 200 to the time of receiving the positioning stop instruction 222, the azimuth calculating unit 202 typically positions an imaging azimuth sequentially, and buffers the plurality of acquired imaging azimuth data in the calculated azimuth buffer 210.

On the other hand, as in FIG. 8, in an example of FIG. 12, although the disturbance components 300 of the imaging unit 110 are sequentially operated to generate a disturbance magnetic field in the imaging processing period, the imaging processing period also includes the period when no disturbance component 300 is operated (operation stop periods T1, T3, T5 and T7). Herein, the imaging controlling unit 200 retains the operation period information representing the operation periods T2, T4 and T6 of the disturbance component 300 in the imaging processing period, and transmits the operation period information together with the positioning stop instruction 222 to the azimuth calculating unit 202 when the imaging processing is completed. Accordingly, the azimuth calculating unit 202 may exclude the operation periods T2, T4 and T6 of the disturbance component 300 from the imaging processing period, and may specify the operation stop periods T1, T3, T5, and T7 of the disturbance component 300. Then, the azimuth calculating unit 202 extracts the imaging azimuth data calculated in the operation stop periods T1, T3, T5 and T7 as effective data among all of the imaging azimuth data retained in the calculated azimuth buffer 210 (data calculated in the periods T1 to T7 during the imaging processing period). Accordingly, the azimuth calculating unit 202 may average the extracted effective data, calculate the average value of the imaging azimuths from which the influence of a disturbance magnetic field is removed, and record the same on the recording medium 140.

As described above, according to the second embodiment, as in the first embodiment, the imaging timing of the captured image (picture) may be adjusted, and an accurate imaging azimuth from which the influence of a disturbance is removed may be recorded as the additional information of the captured image. In addition, according to the second embodiment (see FIG. 12), the control commands transmitted from the imaging controlling unit 200 to the azimuth calculating unit 202 (positioning start instruction, positioning stop instruction, and the like) may be reduced as compared to the first embodiment (see FIG. 8). Accordingly, overhead for control between the imaging controlling unit 200 and the azimuth calculating unit 202 may be reduced, so that more imaging azimuth data may be used to calculate the final azimuth. For example, it can be seen that the effective periods T1, T3, T5 and T7 for azimuth calculation according to the second embodiment (FIG. 12) are longer than the effective periods T1, T2 and T3 for azimuth calculation according to the first embodiment (FIG. 8), and more imaging azimuth data may be used.
[2.5. Application Example of Imaging Azimuth Calculation]

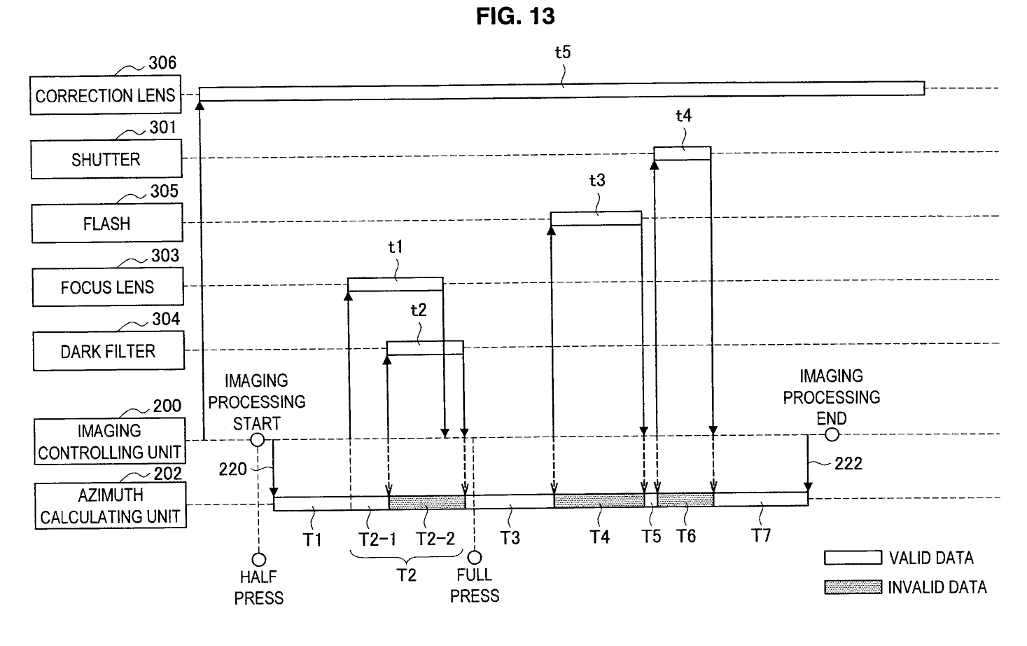

Next, the relation between an operation period of the disturbance component 300 in an imaging processing period and an effective period for calculation of an imaging azimuth by the azimuth calculating unit 202 according to an application example of the second embodiment of the present invention will be described with reference to FIG. 13. FIG. 13 is a timing chart illustrating an operation period of the disturbance component 300 and an effective period for azimuth calculation according to an application example of the second embodiment of the present invention.

As described above, according to the second embodiment, the azimuth calculating unit 202 extracts the imaging azimuth data calculated in the operation stop period of the disturbance component 300 as effective data among the imaging azimuth data in the calculated azimuth buffer 210, and calculates the average value of the imaging azimuths. However, when the operation period of the disturbance component 300 occupies most of the imaging processing period, the number of imaging azimuth data extracted from the calculated azimuth buffer 210 (number of data samplings) may be considered to be smaller than the predetermined number of samplings necessary for calculating the final imaging azimuth. In this case, since the average value of the imaging azimuths may not be suitably calculated, the detection error of the geomagnetic sensor 170 and the calculation error of the azimuth calculating unit 202 may not be sufficiently compensated for.

Thus, when the number of imaging azimuth data extracted as effective data is smaller than the predetermined number of samplings, the azimuth calculating unit 202 selects the disturbance component 300 having a relatively low degree of influence on the detection value of the geomagnetic sensor 170, among the disturbance components 300, based on the influence degree information (see FIG. 10) of the disturbance component 300 included in the disturbance table 232. Then, as illustrated in FIG. 13, the azimuth calculating unit 202 calculates the average value of the imaging azimuths by using the imaging data calculated in a period (T2-1) when only the selected disturbance component 300 is operated, in addition to the extracted imaging azimuth data (calculated in the operation stop periods T1, T3, T5 and T7).

According to the disturbance table 232 illustrated in FIG. 10, the degree of influence of the disturbance component 300 on the geomagnetic sensor 170 differs according to the disturbance components 300. For example, the influence of the flash 305 is highest (100μ tesla), and the degree of influence of the focus lens 303 is lowest (3μ tesla). Thus, among the components 300 of the imaging unit 110, the degree of influence of the focus lens 303 is lowest.

Accordingly, with reference to the disturbance table 232 illustrated in FIG. 10, the azimuth calculating unit 202 selects the disturbance component 300 (for example, the focus lens 303) having a relatively low degree of influence of a disturbance magnetic field on geomagnetism, among the plurality of disturbance components 300 included in the imaging unit 110. Then, as illustrated in FIG. 13, the azimuth calculating unit 202 determines that the degree of influence on geomagnetism is low in the operation period (T2-1) when only the focus lens 303 is operated, among the operation periods T2, T4 and T6 of the disturbance components 300 notified of by the imaging controlling unit 200.

Thus, the azimuth calculating unit 202 uses the operation period (T2-1) when only the focus lens 303 is operated as an effective period, and uses the data of the azimuth calculating unit 202 calculated in the operation period (T2-1) as effective data for calculation of the final azimuth. That is, the azimuth calculating unit 202 extracts not only the imaging azimuth data calculated in the operation stop periods T1, T3, T5 and T7 of the disturbance components 300, but also the imaging azimuth data calculated in the operation period (T2-1) of only the focus lens 303, as effective data, and calculates the average value thereof. In addition, in the operation period (T2-2), in addition to the focus lens 303, the dark filter 304 is also operated, and thus the influence on geomagnetism by a disturbance magnetic field caused by the dark filter 304 is strong. Therefore, the azimuth calculating unit 202 does not extract the imaging azimuth data calculated in the operation period (T2-2), as effective data.

As above, in the second embodiment, according to the degree of influence of the disturbance component 300 on geomagnetism, the imaging azimuth data is weighted, and the imaging azimuth data having a low degree of influence is preferentially extracted. Accordingly, even when the operation period of the disturbance component 300 occupies most of the imaging processing period, the number of data samplings for calculation of the average of the imaging azimuth may be increased. Accordingly, by recording the calculated average of the imaging azimuths as the final azimuth, the detection error of the geomagnetic sensor 170 and the calculation error of the azimuth calculating unit 202 may be sufficiently compensated for.
[3. Conclusion]

The imaging apparatuses 10 and the imaging azimuth calculating and recording methods thereof according to the first and second embodiments of the present invention have been described above. According to the above embodiments, in the imaging processing period of capturing an object by the imaging unit 110 to generate a captured image (picture), the operation period of the disturbance component 300 is detected. Then, during the imaging processing period, based on the detection value detected by the geomagnetic sensor 170 in the period other than the operation period of the disturbance component 300 (that is, the operation stop period of the disturbance component 300), an imaging azimuth is calculated, and the imaging azimuth is recorded as the additional information of the captured image.

Accordingly, the geomagnetic information detected in a limited short period corresponding to the imaging timing may be used to calculate a correct imaging azimuth from which the influence of a disturbance magnetic field of the disturbance component 300 is removed. Also, by recording the calculated imaging azimuth as the additional information representing the azimuth of the imaging direction in capturing a picture, highly-accurate imaging azimuth information may be added to the picture.

Also, even when a disturbance magnetic field is generated by the disturbance component 300 within a limited short period corresponding to the imaging processing period, a more accurate imaging azimuth may be derived as the number of samplings of the averaged imaging azimuth increases. Herein, in the second embodiment, the azimuth calculating unit 202 does not calculate an imaging azimuth in the stop period of the disturbance component 300, but typically calculates an imaging azimuth in the imaging processing period and buffers the same in the calculated azimuth buffer 210. In addition, the timing of the operation start time point and the operation end time point of the disturbance component 300, and the timing of azimuth calculation by the azimuth calculating unit 202 are matched, so that the imaging azimuth data used to calculate the average value of the imaging azimuths is extracted from the imaging azimuth data in the calculated azimuth buffer 210. Accordingly, control overhead exceeding a capacity of a module may be reduced, and the imaging azimuth data calculated in the operation stop period of the disturbance component 300 may be effectively used.

Also, according to the second embodiment, when the operation period of the disturbance component 300 occupies most of the imaging processing period, the disturbance component 300 is weighted according to the degree of influence of the disturbance component 300 on geomagnetism, and the operation period of the disturbance component 300 having a small influence on the geomagnetism is used as an effective period. Then, the imaging azimuth data calculated in the effective period is used as effective data to calculate the final azimuth (average of the imaging azimuths). Accordingly, the number of samplings of the imaging azimuth data for obtaining the final azimuth may be increased to increase the accuracy of the final azimuth information.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

For example, in the above embodiments, when the average value of the imaging azimuths to be recorded as the additional information is obtained, the simple average of the imaging azimuth data retained in the calculated azimuth buffer 210 is calculated. However, the present invention is not limited to such an example. For example, among the imaging azimuth data inside the calculated azimuth buffer 210, the maximum value, the minimum value, abnormal values, and the like may be decimated, and then the imaging azimuth data may be averaged. Accordingly, the influence of the disturbance magnetic field of the disturbance component 300 can be further reduced.

Also, in the above embodiments, the azimuth calculating unit 202 calculates a plurality of imaging azimuths calculated in the imaging processing period and uses the same as the final azimuth. However, the present invention is not limited to such an example. For example, the azimuth calculating unit 202 may use the most frequent value of the plurality of imaging azimuths calculated in the imaging processing period as the final azimuth.

### REFERENCE SIGNS LIST

10 Imaging apparatus

110 Imaging unit

111 Optical imaging system

112 Imaging device

120 Signal processing unit

130 Displaying unit

132 Captured image

134 Compass image

140 Recording medium

150 Controlling unit

151 CPU

160 Operating unit

161 Release button

162 Zoom button

170 Geomagnetic sensor

172 Acceleration sensor

200 Imaging controlling unit

202 Azimuth calculating unit

204 Compass image generating unit

206 Recording unit

208 Reproducing unit

210 Calculated azimuth buffer

212 Zoom position correction table

214,232 Disturbance table

216,220 Positioning start instruction

218,222 Positioning stop instruction

230 Clock

300 Disturbance component

301 Shutter

302 Zoom lens

303 Focus lens

304 Dark filter

305 Flash

306 Correction lens

1. An imaging apparatus comprising:
an imaging unit configured to capture an object according to an imaging start instruction and output a captured image;
a geomagnetic sensor configured to detect geomagnetism;
an imaging controlling unit configured to control components of the imaging unit in an imaging processing period from the imaging start instruction to the output of the captured image, and determine an operation period of a magnetic field generating component affecting a detection value of the geomagnetic sensor, among the components of the imaging unit;
an azimuth calculating unit configured to calculate imaging azimuths based on the detection value detected by the geomagnetic sensor in a period other than the operation period of the magnetic field generating component during the imaging processing period; and
a recording unit configured to record the imaging azimuths on a recording medium in association with the captured image.

2. The imaging apparatus according to claim 1, further comprising:
an azimuth storing unit configured to store the imaging azimuths calculated by the azimuth calculating unit,
wherein the imaging controlling unit
instructs the azimuth calculating unit to start positioning of the imaging azimuths when imaging processing is started by the imaging unit according to the imaging start instruction,
instructs the azimuth calculating unit to stop the positioning of the imaging azimuth when an operation of the magnetic field generating component is started during the imaging processing period,
instructs the azimuth calculating unit to restart the positioning of the imaging azimuth when the operation of the magnetic field generating component is ended during the imaging processing period, and
instructs the azimuth calculating unit to stop the positioning of the imaging azimuth when the imaging processing is ended,
wherein the azimuth calculating unit
sequentially calculates the imaging azimuths based on the detection value of the geomagnetic sensor, in a period from the positioning start to the positing stop instructed by the imaging controlling unit during the imaging processing period, and records the plurality of calculated imaging azimuths in the azimuth storing unit, and
calculates an average of the plurality of imaging azimuths stored in the azimuth storing unit, when the imaging processing is ended, and
wherein the recording unit records the average of the imaging azimuths on the recording medium in association with the captured image.

3. The imaging apparatus according to claim 1, further comprising:
an azimuth storing unit configured to store the imaging azimuths calculated by the azimuth calculating unit,
wherein the imaging controlling unit
instructs the azimuth calculating unit to start positioning of the imaging azimuths when imaging processing is started by the imaging unit according to the imaging start instruction,
generates operation period information representing an operation start time point and an operation end time point of the magnetic field generating component during the imaging processing period, and,
when the imaging processing is ended, instructs the azimuth calculating unit to stop the positioning of the imaging azimuths, and provides the operation period information to the azimuth calculating unit,
wherein the azimuth calculating unit
sequentially calculates the imaging azimuth based on the detection value of the geomagnetic sensor in the imaging processing period, and records the plurality of calculated imaging azimuths and calculation time information representing a calculation time point of each of the plurality of calculated imaging azimuths in the azimuth storing unit in an associated manner, and
when the imaging processing period is ended, extracts the imaging azimuth calculated in a period other than an operation period of the magnetic field generating component among the imaging processing period, among the plurality of imaging azimuths stored in the azimuth storing unit, based on the operation period information acquired from the imaging controlling unit and the calculation time information stored in the azimuth storing unit, and calculates an average of the extracted imaging azimuths, and
wherein the recording unit records the average of the imaging azimuths on the recording medium in association with the captured image.

4. The imaging apparatus according to claim 3, further comprising:
a table associating identification information of the magnetic field generating component with influence degree information of the magnetic field generating component with respect to the detection value of the geomagnetic sensor,
wherein the imaging controlling unit specifies the magnetic field generating component among the components of the imaging unit based on the identification information of the magnetic field generating component included in the table, and determines an operation period of the magnetic field generating component, and
wherein, if the number of the extracted imaging azimuths is smaller than or equal to a predetermined number, the azimuth calculating unit selects a magnetic field generating component having a relatively small influence degree with respect to the detection value of the geomagnetic sensor, among the magnetic field generating components, based on the influence degree information of the magnetic field generating component included in the table, and calculates an average of the imaging azimuths by using the imaging azimuth calculated in a period when only the selected magnetic field generating component is operated and the extracted imaging azimuth.

5. A method of recording an azimuth, comprising:
a step of starting imaging processing of capturing an object by an imaging unit according to an imaging start instruction and outputting a captured image;
a step of controlling components of the imaging unit in an imaging processing period from the imaging start instruction to an output of the captured image, and determining an operation period of a magnetic field generating component affecting a detection value of the geomagnetic sensor, among the components of the imaging unit;
a step of calculating an imaging azimuth based on the detection value detected by the geomagnetic sensor, in a period other than the operation period of the magnetic field generating component, during the imaging processing period; and
a step of recording the imaging azimuth on a recording medium in association with the captured image.

6. A program for causing a computer to execute:
a step of starting imaging processing of capturing an object by an imaging unit according to an imaging start instruction and outputting a captured image;
a step of controlling components of the imaging unit in an imaging processing period from the imaging start instruction to an output of the captured image, and determining an operation period of a magnetic field generating component affecting a detection value of the geomagnetic sensor, among the components of the imaging unit;
a step of calculating an imaging azimuth based on the detection value detected by the geomagnetic sensor, in a period other than the operation period of the magnetic field generating component, during the imaging processing period; and
a step of recording the imaging azimuth on a recording medium in association with the captured image.
